(19) United States
(12) Patent Application Publication
(10) Pub. No.: US 2013/0335427 A1
(43) Pub. Date: Dec. 19, 2013

(54) System and Method for Generating Dynamic Display Ad

(71) Applicants: Matthew CHEUNG, Mississauga (CA); Erik CHARLEBOIS, Toronto (CA); Jeff FRANCIS, Oakville (CA); Wehuns TAN, Oakville (CA)

(72) Inventors: Matthew CHEUNG, Mississauga (CA); Erik CHARLEBOIS, Toronto (CA); Jeff FRANCIS, Oakville (CA); Wehuns TAN, Oakville (CA)

(21) Appl. No.: 13/525,545

(22) Filed: Jun. 18, 2012

(51) Int. Cl. G06T 13/00

(52) U.S. Cl. 345/473

(57) ABSTRACT

In this disclosure, a method and system are disclosed executed on a communication device. The method and system are configured to request for a dynamic display ad from a dynamic display ad system; receive an animation sequence from the dynamic display ad system, the animation sequence comprising one or more instructions to show one or more interest areas on a selected digital flyer; and display the dynamic display ad using the animation sequence, wherein the animation sequence is used to render the dynamic display ad using flyer content of the selected digital flyer.

### TECHNICAL FIELD

The present disclosure relates to display ads and in particular, display ads having dynamic content.

### BACKGROUND

The Internet is fast becoming an indispensable tool. What once used to be primarily a research tool, Internet has become an all purpose tool, where people spend hours researching, socializing, gaming, and otherwise engaging in social, leisure and business activities. To capitalize on the increased time spent by the users, advertisers and publishers have spent incredible amount of resources to reach these users to generate revenues.

Internet advertisements started simple. They were simple images or animated GIFs (Graphics Interchange Formats), showcasing the products or services being promoted. With advancement in Internet technologies, Internet advertisements progressed as well into a more interactive advertisement format using such technologies as Adobe® Flash. While such advertisements were visually appealing and more engaging, the creation of such advertisements were time consuming. Thus, interactive advertisements were often limited to special events or generic content (i.e. not fresh content).

Recently, Internet advertisements having dynamic content have been introduced, using targeted information pertinent to the user. This allowed advertisers to better target audience by presenting information most applicable to the user. However, dynamic content was often limited to text-based information because of the difficulty in curating the visual content. Curation of content was especially difficult when content changed weekly and as well, when there were multiple versions of visual content based on information such as geographic region. Thus, Internet advertisements having dynamic content that showed fresh content such as flyer content were not practical.

Accordingly, systems and methods to generate dynamic flyer content for an image-based digital flyer system for use in display advertisements remain highly desirable.

### SUMMARY

According to an embodiment of the present disclosure, there is disclosed a method executed on a communication device, the method including requesting for a dynamic display ad from a dynamic display ad system; receiving an animation sequence from the dynamic display ad system, the animation sequence comprising one or more instructions to show one or more interest areas on a selected digital flyer; and displaying the dynamic display ad using the animation sequence, wherein the animation sequence is used to render the dynamic display ad using flyer content of the selected digital flyer.

According to another embodiment of the present disclosure, there is disclosed a system for displaying dynamic display ad on a communication device, the system comprising a dynamic display ad module configured to request for a dynamic display ad from a dynamic display ad system; receive an animation sequence from the dynamic display ad system, the animation sequence comprising instructions to show one or more interest areas on the selected digital flyer; and display the dynamic display ad using the animation sequence, wherein the animation sequence is used to render the dynamic display ad using flyer content of the selected digital flyer.

According to a further embodiment of the present disclosure, there is disclosed a computer system including an animation sequence generator configured to generate an animation sequence based on a digital flyer selected from available digital flyer, the animation sequence comprising one or more instructions to show one or more interest areas on the selected digital flyer; and a communication module configured to communicate with a dynamic display ad module to display a dynamic display ad showing the flyer content of the selected digital flyer using the generated animation sequence.

According to an even further embodiment of the present disclosure, there is disclosed a method executed on a computer system, the method including selecting a digital flyer from available digital flyer in response to a request for a dynamic display ad received from a dynamic display ad module; generating an animation sequence based on the selected digital flyer, the animation sequence comprising one or more instructions to show one or more interest areas on the selected digital flyer; and sending the animation sequence to the dynamic display ad module.

According to another embodiment of the present disclosure, there is disclosed a method executed on a communication device, the method including requesting for a dynamic display ad from a dynamic display ad system; receiving a rendered animation from the dynamic display ad system, the rendered animation generated from an animation sequence comprising one or more instructions to show one or more interest areas on a selected digital flyer; and displaying the rendered animation.

According to a further embodiment of the present disclosure, there is disclosed a system for displaying dynamic display ad on a communication device, the system including a dynamic display ad module. The dynamic display ad module is configured to request for a dynamic display ad from a dynamic display ad system; receive a rendered animation from the dynamic display ad system, the rendered animation generated from an animation sequence comprising one or more instruction to show one or more interest areas on a selected digital flyer; and display the rendered animation.

According to an even further embodiment of the present disclosure, there is disclosed a method executed on a computer system, the method including selecting a digital flyer from available digital flyer in response to a request for a dynamic display ad received from a dynamic display ad module; generating an animation sequence based on the selected digital flyer, the animation sequence comprising one or more instructions to show one or more interest areas on the selected digital flyer; generating a rendered animation from the animation sequence; and sending the rendered animation to the dynamic display ad module.

According to another embodiment, a computer system is disclosed. The computer system includes an animation sequence generator configured to generate an animation sequence based on a digital flyer selected from available digital flyer, the animation sequence comprising one or more instructions to show one or more interest areas on the selected digital flyer; a rendered animation generator configured to generate a rendered animation using the animation sequence generated by the animation sequence generator, the rendered animation showing the one or more interest areas of the selected digital flyer; and a communication module configured to communicate with a dynamic display ad module.

According to an embodiment of the present disclosure, there is disclosed a computer-readable storage medium comprising instructions in code which when loaded into a memory and executed by a processor causes the communication device to request for a dynamic display ad from a dynamic display ad system; receive an animation sequence from the dynamic display ad system, the animation sequence comprising one or more instructions to show one or more interest areas on a selected digital flyer; and display the dynamic display ad using the animation sequence, wherein the animation sequence is used to render the dynamic display ad using flyer content of the selected digital flyer.

According to another embodiment of the present disclosure, there is disclosed a computer-readable storage medium comprising instructions in code which when loaded into a memory and executed by a processor causes the computer system to select a digital flyer from available digital flyer in response to a request for a dynamic display ad received from a dynamic display ad module; generate an animation sequence based on the selected digital flyer, the animation sequence comprising one or more instructions to show one or more interest areas on the selected digital flyer; and send the animation sequence to the dynamic display ad module.

According to a further embodiment of the present disclosure, there is disclosed a computer-readable storage medium comprising instructions in code which when loaded into a memory and executed by a processor causes a communication device to request for a dynamic display ad from a dynamic display ad system; receive a rendered animation from the dynamic display ad system, the rendered animation generated from an animation sequence comprising one or more instructions to show one or more interest areas on a selected digital flyer; and display the rendered animation.

According to an even further embodiment of the present disclosure, there is disclosed a computer-readable storage medium comprising instructions in code which when loaded into a memory and executed by a processor causes a computer system to select a digital flyer from available digital flyer in response to a request for a dynamic display ad received from a dynamic display ad module; generate an animation sequence based on the selected digital flyer, the animation sequence comprising one or more instructions to show one or more interest areas on the selected digital flyer; generate a rendered animation from the animation sequence; and send the rendered animation to the dynamic display ad module.

According to some of the embodiments discussed herein, there is disclosed displaying an initial image of the selected digital flyer received from the dynamic display ad system.

According to some of the embodiments discussed herein, the one or more interest areas of the selected digital flyer are determined using one or more intrinsic factors, one or more extrinsic factors, one or more feedback information, or a combination thereof.

According to some of the embodiments discussed herein, the animation sequence further comprises one or more transition actions.

According to some of the embodiments discussed herein, displaying the dynamic display ad using the animation sequence includes retrieving a next instruction of the animation sequence; requesting, to the dynamic display ad system, for a flyer image representing the interest area in the next instruction; displaying the flyer image received from the dynamic display ad system; and repeating the retrieval of a next instruction, request for a flyer image and display of the flyer image for all instructions in the animation sequence.

According to some of the embodiments discussed herein, the animation sequence comprises one or more transition actions and further includes requesting, to the dynamic display ad system, for a flyer image displayable in the dynamic display ad during execution of one of the one or more transition actions; and displaying the flyer image received from the dynamic display ad system.

According to some of the embodiments discussed herein, there is disclosed requesting, to the dynamic display ad system, for a flyer image representing the interest area not yet displayable in the dynamic display ad.

According to some of the embodiments discussed herein, there is disclosed detecting an interaction with the dynamic display ad; and triggering a secondary experience.

According to some of the embodiments discussed herein, triggering a secondary experience includes requesting, to the dynamic display ad system, for the flyer image of the selected digital flyer displayable in a viewport of the communication device; and displaying the flyer image received from the dynamic display ad system.

According to some of the embodiments discussed herein, triggering a secondary experience includes requesting for the flyer image of the selected digital flyer displayable in a viewport of the communication device; and displaying the received flyer image.

According to some of the embodiments discussed herein, displaying the flyer image received from the dynamic display ad system comprises overlaying the received flyer image over the dynamic display ad.

According to some of the embodiments discussed herein, there is disclosed requesting, to the dynamic display ad system, for the flyer image of the selected digital flyer not yet displayable in the viewport of the communication device.

According to some of the embodiments discussed herein, there is disclosed requesting for the flyer image of the selected digital flyer not yet displayable in the viewport of the communication device.

According to some of the embodiments discussed herein, there is disclosed collecting user state information of the user viewing the dynamic display ad on the communication device; and incorporating the collected user state information with the request for the flyer image.

According to some of the embodiments discussed herein, the user state information comprises viewport information, position of the flyer image, browser information, device information or a combination thereof.

According to some of the embodiments discussed herein, there is disclosed collecting flyer-related information of the digital flyer being displayed in the dynamic display ad; and incorporating the collected flyer-related information with the request for the flyer image.

According to some of the embodiments discussed herein, there is disclosed collecting configuration information of the dynamic display ad; and incorporating the collected configuration information with the request for the dynamic display ad.

According to some of the embodiments discussed herein, there is disclosed generating an initial image of the selected digital flyer; and sending the initial image to be displayed by the dynamic display ad module.

According to some of the embodiments discussed herein, generating an initial image of the selected digital flyer comprises retrieving a pre-generated initial image for the selected digital flyer from memory.

According to some of the embodiments discussed herein, generating an initial image of the selected digital flyer comprises creating the initial image using flyer content of the selected digital flyer.

According to some of the embodiments discussed herein, creating the initial image using flyer content of the selected digital flyer includes selecting a template from one or more available templates; and creating the initial image based on the selected template.

According to some of the embodiments discussed herein, generating an animation sequence based on the selected digital flyer comprises retrieving a pre-generated animation sequence for the selected digital flyer from memory.

According to some of the embodiments discussed herein, generating an animation sequence based on the selected digital flyer comprises retrieving a pre-generated animation sequence for the selected digital flyer from memory.

According to some of the embodiments discussed herein, generating a rendered animation from the animation sequence comprises retrieving a pre-generated rendered animation for the animation sequence from memory.

According to some of the embodiments discussed herein, generating a rendered animation from the animation sequence comprises retrieving a next instruction of the animation sequence; requesting for a flyer image representing the interest area in the next instruction; displaying the flyer image received from the dynamic display ad system; and repeating the retrieval of a next instruction, request for a flyer image and display the flyer image for all instructions in the animation sequence.

According to some of the embodiments discussed herein, creating the animation sequence based on one or more interest areas on the selected digital flyer includes selecting a template from one or more available templates; and creating the animation sequence based on the selected template.

According to some of the embodiments discussed herein, there is disclosed pre-generating one or more animation sequences based on one or more criteria.

According to some of the embodiments discussed herein, the one or more criteria for pre-generation of the one or more animation sequences comprises one or more intrinsic factors, one or more extrinsic factors, one or more feedback information, or a combination thereof.

According to some of the embodiments discussed herein, the one or more transition actions comprises a pan, pause, zoom, rotate, fade or a combination thereof.

According to some of the embodiments discussed herein, the animation sequence further comprises a text, pictorial or audio-visual information.

According to some of the embodiments discussed herein, the digital flyer is selected from the available digital flyer based on relevance, wherein the relevance is based on targeting information.

According to some of the embodiments discussed herein, the targeting information comprises user-related information received from the dynamic display ad module.

According to some of the embodiments discussed herein, the targeting information includes flyer-related information.

According to some of the embodiments discussed herein, there is disclosed a cover shot generator configured to generate an initial image of the selected digital flyer.

### BRIEF DESCRIPTION OF THE DRAWINGS

Further features and advantages of the present technology will become apparent from the following detailed description, taken in combination with the appended drawings, in which:

FIG. 1 illustrates a block diagram of the ecosystem required in serving a digital ad over a communication network;

FIG. 2 illustrates a block diagram of the ecosystem required in serving a dynamic display ad over a communication network;

FIG. 3 illustrates a block diagram of an embodiment of the dynamic display ad system;

FIG. 4 illustrates a block diagram of an embodiment of the digital flyer system;

FIG. 5 illustrates a web page incorporating a dynamic display ad according to an embodiment of this disclosure;

FIG. 6 illustrates an exemplary interaction between the dynamic display ad module, dynamic display ad system and digital flyer system for retrieving a digital flyer for creating a dynamic display ad;

FIG. 7 illustrates an embodiment process for generating the animation sequence;

FIG. 8 illustrates an exemplary interaction between the dynamic display ad module, dynamic display ad system and digital flyer system for displaying the dynamic display ad;

FIG. 9 illustrates an exemplary interaction between the dynamic display ad module, dynamic display ad system and digital flyer system when a user engages the dynamic display ad;

FIG. 10 illustrates an exemplary animation sequence and the associated digital flyer for execution;

FIGS. 11A-I illustrate an exemplary execution of the animation sequence as shown in FIG. 10;

FIG. 12 illustrates an exemplary secondary experience stemming from FIG. 11E;

FIG. 13 illustrates an exemplary secondary experience stemming from FIG. 11H;

FIG. 14 illustrates an exemplary interaction between the dynamic display ad module, dynamic display ad system and digital flyer system for retrieving a digital flyer for creating a dynamic display ad;

FIG. 15 illustrates an exemplary interaction between the dynamic display ad module, dynamic display ad system and digital flyer system for rendering the animation sequence; and

FIG. 16 illustrates an exemplary interaction between the dynamic display ad module, dynamic display ad system and digital flyer system when a user engages the dynamic display ad.

It will be noted that throughout the appended drawings, like features are identified by like reference numerals.

### DETAILED DESCRIPTION

In this specification and the appended claims, the singular forms “a,” “an,” and “the” include plural references unless the context clearly dictates otherwise. Unless defined otherwise, all technical and scientific terms used herein have the same meaning as commonly understood to one of ordinary skill in the art to which this disclosure belongs.

It will be further understood that the terms “comprises” or “comprising”, or both when used in this specification, specify the presence of stated features, integers, steps, operations, elements, and/or components, but do not preclude the presence or addition of one or more other features, integers, steps, operations, elements, components, and/or groups thereof.

The term “flyer” in the present disclosure is used generally to refer to flyers, circulars, handbill, leaflet, catalogue, and other forms of distributed advertisements.

The term “wireless communication technology” is intended to describe any communication protocol that enables a communication device to communicate with a server without wires. By way of example, but not limitation, wireless communication protocol may include IEEE 802.11x standards (sometimes referred to as Wi-Fi) such as, for example, the IEEE 802.11a, 802.11b, 802.11g, and/or 802.11n standard. Other communication protocols include: IEEE 802.16e (also referred to as Worldwide Interoperability for Microwave Access or “WiMAX”); IEEE 802.20 (also referred to as Mobile Wireless Broadband Access); Mobitex Radio Network, DataTAC; GPRS (General Packet Radio System); TDMA (Time Division Multiple Access) including GSM (Global System for Mobile Communication); CDMA (Code Division Multiple Access) including CDMA 2000 and UTRA (Universal Terrestrial Radio Access); FDMA (Frequency Division Multiple Access); OFDMA (Orthogonal FDMA), SC-FDMA (Single-Carrier FDMA); CDPD (Cellular Digital Packet Data); iDEN (integrated Digital Enhanced Network); EvDO (Evolution-Data Optimized); EDGE (Enhanced Data rates for GSM Evolution); UMTS (Universal Mobile Telecommunication Systems); HSPDA (High-Speed Downlink Packet Access); and other various network technologies, including LTE-advanced technologies. An OFDMA system utilizes Orthogonal Frequency Division Multiplexing (OFDM) and sends modulation symbols in the frequency domain on orthogonal subcarriers, and may be implemented in technologies such as E-UTRA or E-UTRAN.

The details and particulars of these aspects of the technology will now be described below, by way of example, with reference to the attached drawings.

### Overview

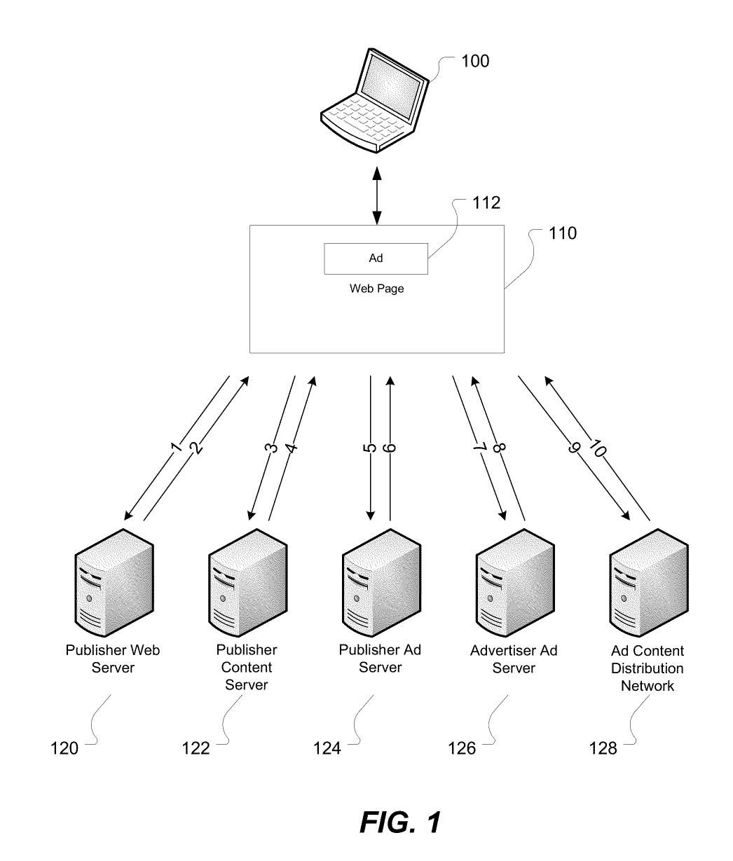

Referring to FIG. 1, there is shown a block diagram of the interaction required in serving a digital ad over a communication network (e.g. Internet). In FIG. 1, a user on a communication device 100 is browsing through web page 110 using wired or wireless communication technology known to the person skilled in the art. While FIG. 1 shows one user 100 browsing the web page 110 on a laptop, it will be understood that there may be one or many users 100 accessing the web page 100 on any type of communication device. On the web page 110, there is shown an ad 112, promoting the product or service of an advertiser. While the web page 110 is shown with one ad 112, it will be understood that there may be a plurality of ads 112 on web page 110 in various formats. FIG. 1 is simplified for illustration purpose only.

When the user 100 browses to web page 110 using a web address (e.g. URL), a request (1) is made to the publisher's web server 120. The publisher web server 120 returns (2) code that provides where to retrieve the content on the web page 110 and how to format such content. The content on web page 110 can be retrieved (i.e. request (3) and receive (4)) from publisher content server 122. It will be understood that the publisher content server 122 may not be the sole location where content associated with web page 110 is located. However, for the purpose of this example and other examples and embodiments described in this disclosure, content related to web page 110 and other web page will be located on publisher content server 122. The content retrieved from publisher content server 122 may also include one or more ad placeholders, with each ad placeholder including information regarding where and how to retrieve the ad. This is typically in the form of one or more ad tags that point to an ad server, such as publisher ad server 124. While this disclosure discloses the one or more ad tags pointing to the publisher ad server 124, it will be understood that the ad tags may point directly to advertiser ad server 126. Further, it will be understood that ad tags may be in many different forms to indicate where and how to retrieve information about advertisements.

The publisher ad server 124 contains a collection of ads that the publisher can serve to the requesting web page and thus, through request (5) and receipt (6), information regarding the ad to display is sent to the user 100. The publisher ad server 124 may be owned and operated by the publisher or part of a large network of ad servers. While publisher ad server 124 may contain the actual ad creative and information related thereto, information regarding the ad to display on web page 110 is typically located on the advertiser's ad server. The reasons are: (i) convenience and (2) tracking. Since the publisher has a supply of advertising space available for purchase by advertisers, and there are numerous different advertisers who buy such ad space, information regarding the ad creative of the advertiser is located on the advertiser ad server 126. This allows each advertiser to maintain a separate record of advertisements that have been displayed on the publisher's web site and as well, it allows advertisers to more easily update the ad creative without contacting the many different publishers from whom the advertisers may be purchasing ad space. Thus, a further request (7) is made to advertiser ad server 126 to retrieve (8) information regarding the advertisers ad.

Further, after retrieving information regarding the advertiser's advertisement from advertiser ad server 126, the actual ad creative may be retrieved from ad content distribution network 128 (i.e. through request (9) and receipt (10)). The ad content distribution network 128 is a robust network of servers that can handle the heavy bandwidth and volume requirement in delivering ad creative (which may be image files, animated GIFs and other animated and static formats) to the different number of users on the Internet. While some advertiser ad server 126 may be sufficiently powerful to handle such requirement (thereby eliminating the need for the ad creative to sit on the ad content distribution network 128), advertiser may store the numerous ad creatives on the robust ad content distribution network 128 to handle such requests.

Thus, as depicted in FIG. 1, when a user 100 browses to web page 110 with ad 112, numerous requests are made, completely transparent to user 100, to retrieve and record the advertisements that are served to the user 100. These numerous requests are typically completed in mere milliseconds. Such requests may be made through known techniques in the art such as HTTP 302 redirects.

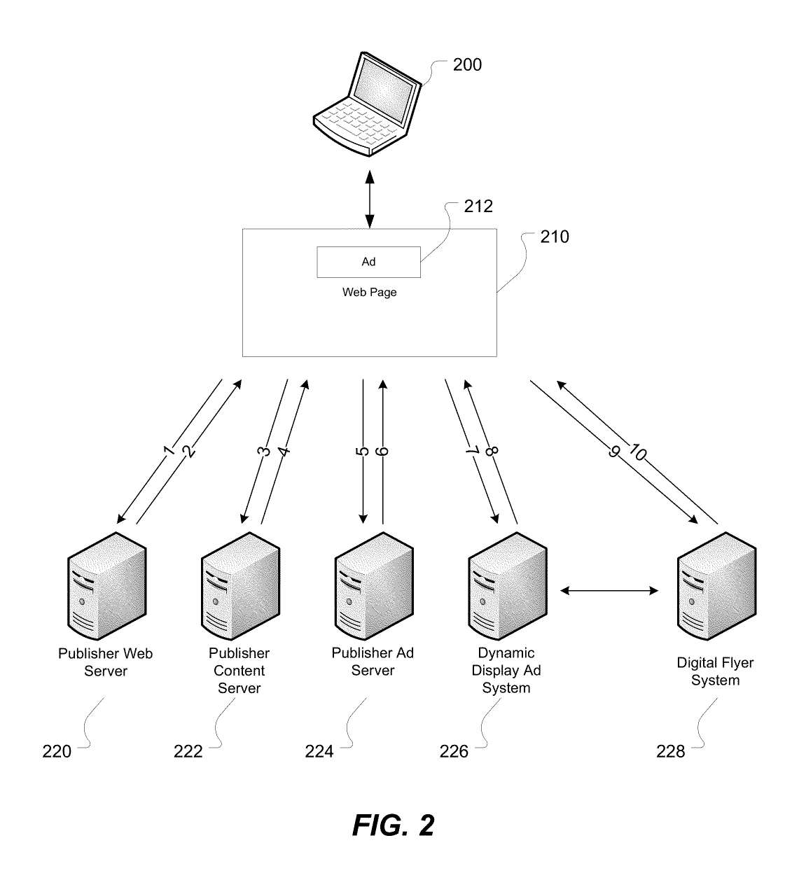

Now referring to FIG. 2, there is shown a block diagram of an exemplary interaction for providing dynamic display ad according to an embodiment disclosed in this disclosure. As depicted in FIG. 2, the user 200 similarly accesses the web page 210 having dynamic display ad 212. Thereafter, interaction with publisher web server 220, publisher content server 222 and publisher ad server 224 remain similar to those of FIG. 1. When the user 200 is redirected from the publisher ad server 224 to retrieve information regarding the advertiser's ad, a specialized ad server, referred to herein as dynamic display ad system 226, responds to the request (7). While this disclosure discloses being redirected from the publisher ad server 224 to the dynamic display ad system 226, it will be understood that content retrieved from publisher content server 222 may contain information regards ads that directly point to the dynamic display ad system 226.

The dynamic display ad system 226 provides the necessary information to generate the dynamic display ad 212. The dynamic display ad 212 then interacts with digital flyer system 228 to receive content regarding the digital flyer and render the dynamic display ad 212 using the received content. Thus, the dynamic display ad 212 is able to work with the existing advertising network and seamlessly plug into the available supply of advertising space. While the present disclosure discloses the dynamic display ad system 226 and digital flyer system 228 separately, it will be understood that the dynamic display ad system 226 and the digital flyer system 228 may be part of the same system

The embodiments of the dynamic display ad system 226 and digital flyer system 228 will now be described.

### Dynamic Display Ad System & Digital Flyer System

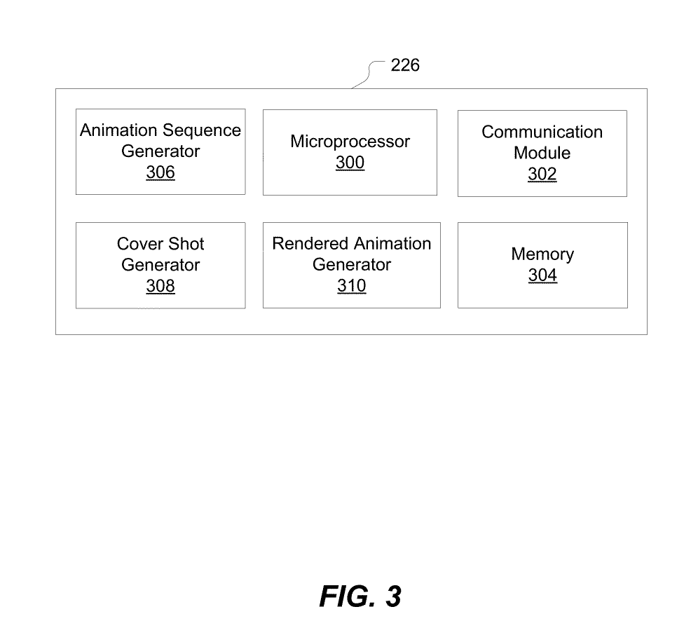

The dynamic display ad system 226, as shown in FIG. 2, may serve as the advertiser's ad server for responding to request for dynamic display ad 212. In addition to serving dynamic display ad 212, the dynamic display ad system 226 may act as a regular ad server to serve standard display ads. In FIG. 3, there is shown a block diagram of an embodiment of the dynamic display ad system 226. It should be expressly understood that this figure is intentionally simplified to show only certain main components. The dynamic display ad system 226 may include other components beyond what is illustrated in FIG. 3.

The dynamic display ad system 226 includes a microprocessor 300, a communication module 302 and memory 304. The communication module 302 may be used to communicate (using wired or wireless communication technologies) with web pages and ad units on the web pages, such as web page 110, 210, ad 112 and dynamic display ad 212. As it will be further discussed in this disclosure, the communication module 302 may also communicate with digital flyer system 228 to retrieve digital flyer information. The dynamic display ad system 226 also includes memory 304, which may store user (e.g. user 100, 200) information, animation sequence information (previously generated by the animation sequence generator 306), cover shot information (previously generated by the cover shot generator 308). Furthermore, the memory 304 may be used by the microprocessor 300 when handling processing requests from the different modules within the dynamic display ad system 226, such as communication module 302, animation sequence generator 306 and cover shot generator 308.

The dynamic display ad system 226 also includes an animation sequence generator 306 and optionally a cover shot generator 308. The animation sequence generator 306 is used to generate the animation sequence based on the flyer content retrieved from the digital flyer system 228. As it will be further explained in this disclosure, the animation sequence generator 306 identifies one or more interest areas on the digital flyer communicated from the digital flyer system 228 using one or more criteria, and generates an animation sequence to walk the users through the interest areas on the digital flyer. This animation sequence is used by the dynamic display ad 212 to render the animation in real time. In addition to the animation sequence generator 306, the cover shot generator 308 may be used to generate an initial imaging sequence to be used by the dynamic display ad 212 while the animation sequence generator 306 creates the animation sequence. In a further embodiment, the dynamic display ad system 226 may also include a rendered animation generator 310. The rendered animation generator 310 may be used to render the animation sequence at the dynamic display ad system 226 to generate the rendered animation, which may be communicated to the dynamic display ad module to be displayed.

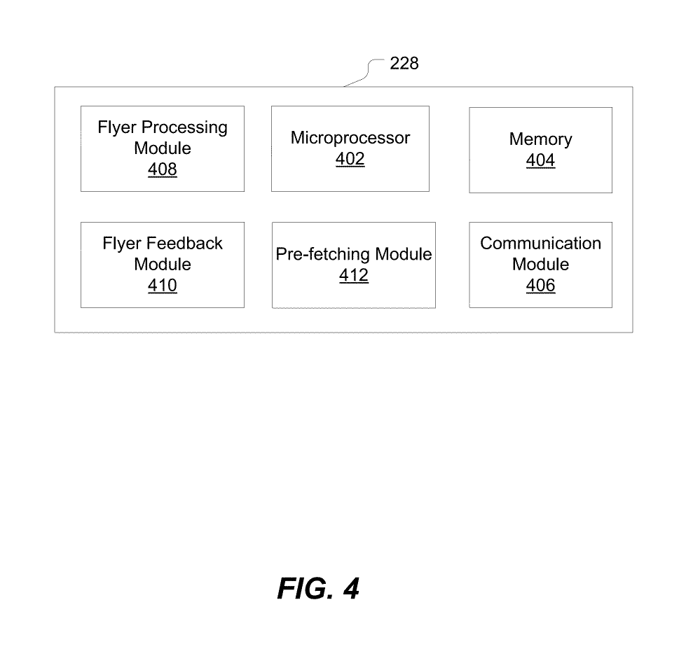

In FIG. 2, there is also shown a digital flyer system 228. The digital flyer system stores the digital flyer and interacts with the dynamic display ad 212 to retrieve and deliver the flyer images as requested by the dynamic display ad 212. One embodiment of the digital flyer system 228 is shown in FIG. 4, including a microprocessor 402, memory 404 and communication module 406. Memory 404 may be implemented using any known memory module such as Flash, SSD, RAM and any other technologies known to the person skilled in the art. The memory 404 may be used to store flyer image and other flyer related information associated with the digital flyer and may also be used as general memory for the different modules present in the digital flyer system 228. The communication module 406 may include wired or wireless technologies or both.

In this embodiment, the digital flyer system 228 may further include a flyer processing module 408 to process the request for the digital flyer and the flyer images associated with such digital flyer. The flyer images discussed herein may be implemented using the flyer image tile technology disclosed in U.S. patent application Ser. Nos. 13/011,602 and 13/011,612 (“Commonly Owned patent applications—Digital Flyer System”), which are incorporated herein by reference. In a further embodiment, the digital flyer system 228 may include flyer feedback module 410, which may be implemented using the technology disclosed in Commonly Owned patent applications—Digital Flyer System. In an even further embodiment, the digital flyer system 228 may include a pre-fetching module 412, which may be implemented using the technology disclosed in the U.S. patent application Ser. No. 13/299,528 (“Common Owned patent application—Pre-Loading”), which is incorporated herein by reference.

### Dynamic Display Ad Creation

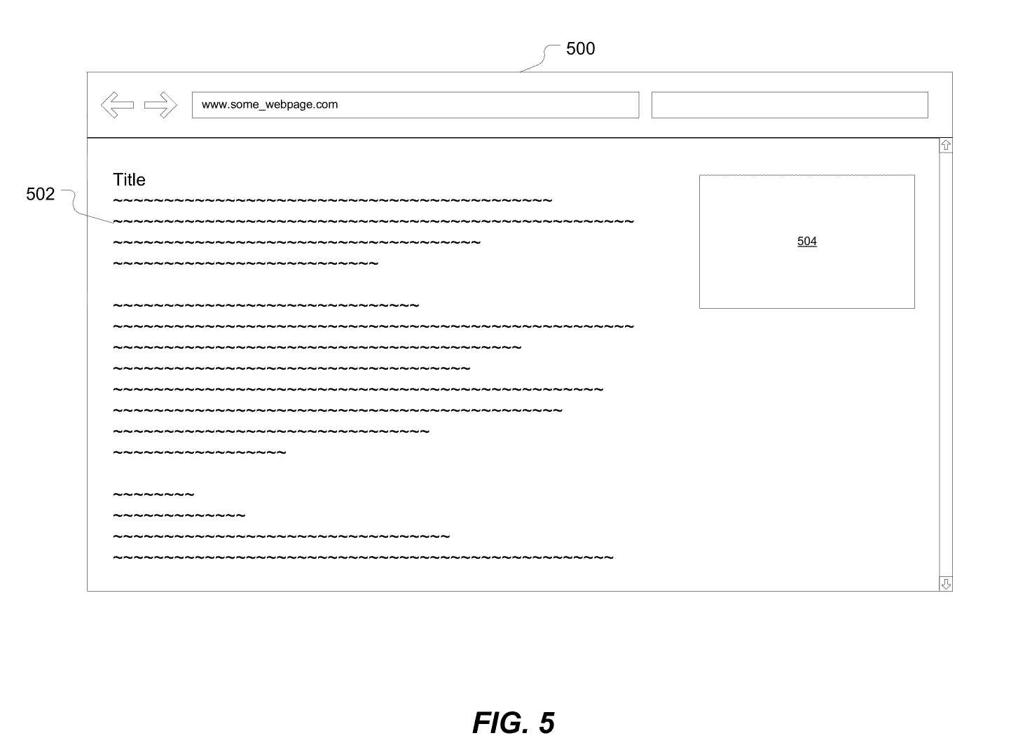

Now, referring to FIG. 5, there is shown a web page 500. The web page 500 contains some content 502 as well as an ad placeholder 504 designed to insert advertisements and drive revenues for the publisher of the web page 500. The ad placeholder 504 may or may not be according to a standard ad unit using standards established by recognized ad unit guidelines such as those established by the Interactive Advertising Bureau (IAB). While web page 500 is shown with one ad placeholder 504, it will be understood that there may be one or more ad placeholders as shown in FIG. 5.

When user browses to the web page 500, the content for the page is retrieved from the publisher content server (e.g. 222 in FIG. 2). Along with content 502, information regarding advertisement may be embedded into the content 502 in the form of ad tags, which may be in a form well known to the person skilled in the art, to retrieve the appropriate advertisements into the ad placeholder 504. The ad tag is then used to direct the web page 500 to the publisher ad server (e.g. 224 in FIG. 2). While the publisher ad server may select from a number of available advertisements for display in the ad placeholder 504, the ad tags embedded into web page 500 may selectively request a dynamic display ad for insertion into the ad placeholder 504. It will be understood that the ad tags incorporated into the content may be specifically formatted to retrieve dynamic display ads according to an embodiment in this disclosure. The publisher ad server retrieves the ad information related thereto and sends the information to the user.

In one embodiment, the ad tag retrieves a dynamic display ad module. The dynamic display ad module is configured to communicate with the dynamic display ad system 226 to select the digital flyer and render the dynamic display ad using the animation sequence as it will be described in this disclosure. In one embodiment, the dynamic display ad module may be stored on the publisher ad server 224. In another embodiment, the ad tag may retrieve the necessary information from the publisher content server 222 or publisher ad server 224 to retrieve the dynamic display ad module from the dynamic display ad system 226 or from another resource storage facility. Advantageously, by retrieving the dynamic display ad module from the dynamic display ad system 226 or from another resource storage facility, advertisers could easily update the dynamic display ad module.

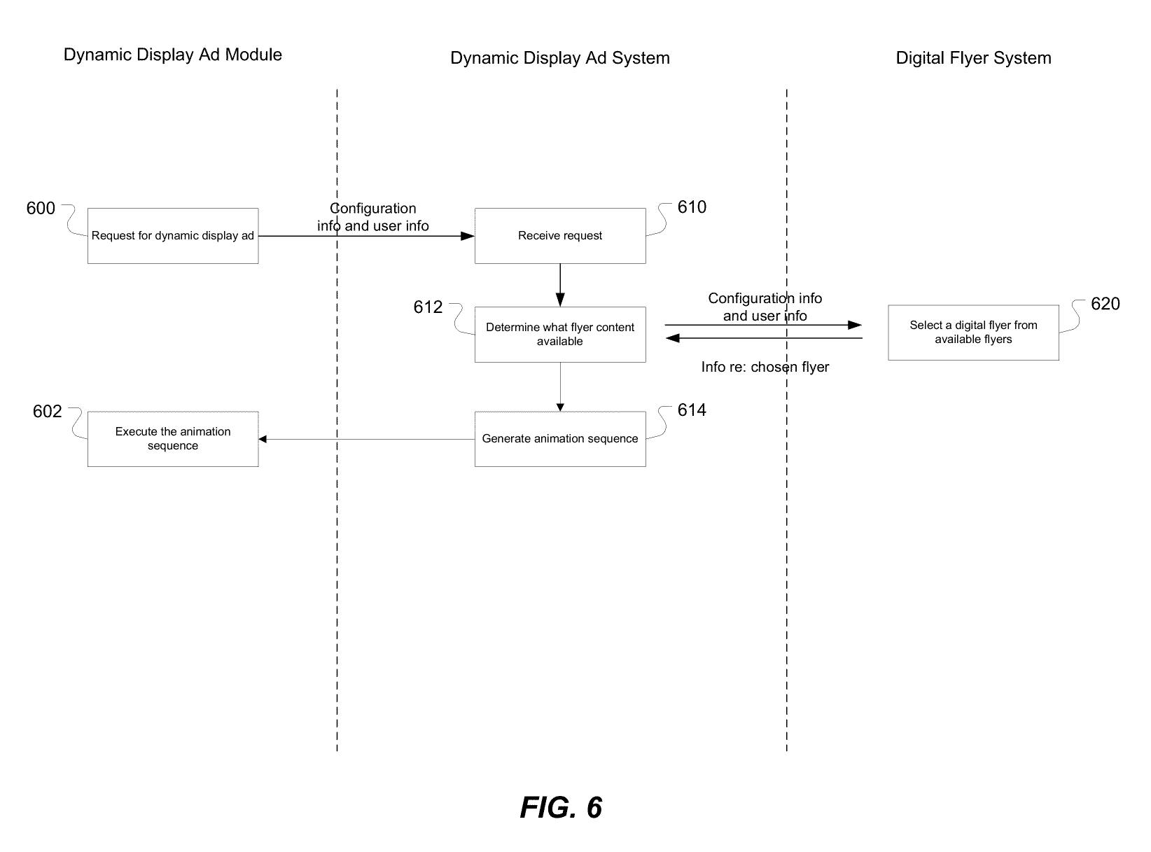

With the dynamic display ad module downloaded into the ad placeholder 504, a request for a dynamic display ad is sent to the dynamic display ad system 226, an embodiment which is shown in FIG. 6. In the request, information regarding the configuration of the dynamic display ad module, such as width and height, and user information, such as information stored in cookies, content of the web page (e.g. content 502 in web page 500), geographical location and time, may be sent along with this request. This request is received by the dynamic display ad system (i.e. 610 in FIG. 6), which initiates communication with the digital flyer system to select the digital flyer from which to create the dynamic display ad (i.e. 612 and 620 in FIG. 6). While a random digital flyer may be chosen by the digital flyer system, to better target the digital flyer served to the user, the dynamic display ad system may also pass along information received from the dynamic display ad module. For example, retailers often have many different versions of a flyer (e.g. per geographic zone to reflect the prices therein) for distribution. By using relevant information passed from the dynamic display ad module, the dynamic display ad system is able to select the most relevant digital flyer for the user viewing the dynamic display ad. For example, the dynamic display ad module may convey user-related information, including device information. Additionally, the digital flyer system may also consider flyer-related information, such as flyer availability, engagement rates, revenue potential, popularity, frequency of recent selection, and other flyer-related information. Flyer-related information may be passed from the dynamic display ad module or retrieved from the digital flyer system. The information passed from the dynamic display ad module and flyer related information (whether retrieved from the digital flyer system or received from the dynamic display ad module) may be used to generate a flyer score for the selection of the digital flyer. Once selected, information regarding the selected digital flyer is returned to the dynamic display ad system.

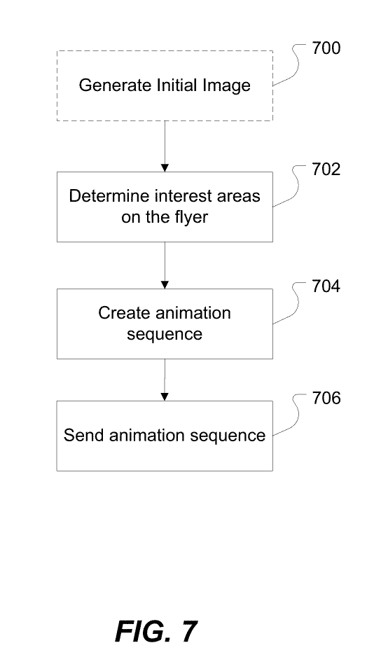

With the digital flyer selected, the dynamic display ad system generates an animation sequence for the selected digital flyer (i.e. 614 in FIG. 6), which may be accomplished in a number of ways. In one embodiment, the dynamic display ad system has a collection of pre-generated animation sequence that is retrieved from memory, from which a digital flyer is selected and sent to the dynamic display ad module for execution. The pre-generated animation sequence may have been cached from a previous creation of the animation sequence (e.g. FIG. 7). Alternatively, or additionally, the dynamic display ad system may pre-generate animation sequence for one or more of the available digital flyers in the digital flyer system depending on one or more criteria. The criteria for pre-generation may be based on, for example, flyer availability, flyer popularity, revenue potential of the digital flyer, and other intrinsic factors, extrinsic factors and feedback information. In another embodiment, the dynamic display ad system may create the animation sequence in real time. Referring to FIG. 7, the dynamic display system may determine the interest areas on the selected digital flyer (i.e. 702 in FIG. 7). The interest areas on the selected digital flyer may be determined by considering one or more intrinsic factors, one or more extrinsic factors, one or more feedback information, or a combination thereof. In another embodiment, the interest areas of the selected digital flyer may be pre-determined by a retailer associated with the digital flyer, or by another user of the digital flyer system. In this disclosure, the intrinsic factors relate to the actual offers and deals present on the digital flyer. For example, intrinsic factors may include location of the product/offer on the digital flyer, physical size of the product/offer on the digital flyer, price or discount associated with the product/offer, limited quantities or time of the product/offer, image qualities, product or offer highlights, and other information related to the digital flyer or the product/offer on the digital flyer itself. Moreover, the intrinsic factors may relate to the revenue potential of the digital flyer. As for the extrinsic component, this relates to information external to the digital flyer yet relevant to the viewer of the digital flyer. For example, weather condition at the location of the viewer, special events applicable to the viewer, holidays and other relevant extrinsic information. For the feedback component, this refers to the information collected from past viewers of the digital flyer. For example, the feedback information may include engagement patterns of past viewers, popularity of the product/offer and other feedback information, explicit or implicit, gathered from the viewers of the digital flyer. In one embodiment, feedback information may be determined using feedback information available for the selected digital flyer, such as those discussed in the Commonly Owned patent applications—Digital Flyer System. Using the one or more intrinsic factors, one or more extrinsic factors, one or more feedback information, one or more pre-determined interest areas, or any combination thereof, the dynamic display ad system selects the interest areas on the digital flyer to create the animation sequence.

With the interest areas determined, the dynamic display ad system creates the animation sequence (i.e. 704 in FIG. 7). The animation sequence is a series of instructions configured to walk the viewer of the dynamic display ad through the interest areas. In one embodiment, the animation sequence comprises of one or more of the interest areas shown in order, similar to a slideshow. In another embodiment, the animation sequence may walk the viewer of the digital flyer through the digital flyer, showcasing each interest area. In this embodiment, transition actions may be added to the animation sequence. Transition actions may include pan, pause, zoom, fade, rotate or any combination thereof to add emphasis to each of the interest area. An example of a combination of the transition actions may be a parabolic zoom, which includes the combination of a zooming action with a panning action. In a further embodiment, the animation sequence may further include a text, pictorial or audio-visual information, such as annotation, narration or overlay or any other text, pictorial or audio-visual information. For example, the dynamic display ad module may overlay a redeemable coupon over a portion of the interest area to encourage the viewer to engage with the dynamic display ad. In a further example, the dynamic display ad module may display a quick video promotion of the product contained in the interest area. In an even further example, the dynamic display ad module may include an audio narration of the interest areas on the digital flyer to add emphasis to the products or offers being promoted by the dynamic display ad.

It will be understood that the foregoing methods of creating the animation sequence may be based on one or more templates with predefined number of interest areas with predefined, random or selected transition action. For example, the template may specify that the animation sequence requires a cover shot followed by n number of interest areas with appropriate selected transition actions in between the interest areas. The selection of the transition action may be pre-determined or may be based on one or more factors, such as the location of the interest areas, the type of offers/products in the interest areas, text, pictorial or audio-visual annotations or inserts required, and any other factors that may influence the display of the dynamic display ad. Thus, the dynamic display ad system may select a template from a collection of available templates and create the animation sequence based on the selected template. The created animation sequence is then sent to the dynamic display ad module (i.e. 706 in FIG. 7). Additionally, the dynamic display ad system may store the created animation sequence in memory to be reused.

In another embodiment, the dynamic display ad system may optionally generate an initial image (i.e. 700 in FIG. 7). The initial image, or also referred herein as a cover shot, is the initial image displayed by the dynamic display ad module while the dynamic display ad generates the animation sequence. While the term “cover shot” may be used in this disclosure, it will be understood that “cover shot” does not necessarily refer to the front page of the digital flyer. It generally refers to the initial image to be displayed within the dynamic display ad representing the selected digital flyer.

Generation of the initial image may be achieved in a variety of ways. In one embodiment, the dynamic display ad system may have a collection of pre-generated cover shots for the selected digital flyer stored in memory. The pre-generated cover shots may have been cached from a previous creation of the cover shot by the cover shot generator. Alternatively, or additionally, the dynamic display ad system may pre-generate a number of cover shots for one or more of the available digital flyers depending on one or more criteria, such as criteria discussed in this disclosure. For example, a cover shot may be generated for each of the pre-generated animation sequence as discussed in this disclosure. In another embodiment, the initial image created may be an excerpt of a page of the digital flyer. In a further embodiment, the initial image created may be a special message page specifically designated or created by the retailer associated with the selected digital flyer. This special message may be intended to attract the attention of the viewer visiting the publisher's web page. In an even further embodiment, the initial image may be created using a template configured to showcase certain information to the viewer. For example, the template may be configured to insert the logo of the retailer and portions of the digital flyer. In another example, the template may be configured to insert popular or featured items on the selected digital flyer. The popularity of the item may be determined using feedback information available from a feedback system such as the feedback system discussed in Commonly Owned patent applications—Digital Flyer System.

The initial image of the selected digital flyer is sent to the dynamic display ad module, which is used to showcase the digital flyer within the dynamic display ad module while the dynamic display ad system generates the animation sequence. Advantageously, by generating the initial image and displaying the initial image while generating the animation sequence, the time interval between a first image being displayed in the dynamic display ad module and the animation sequence being displayed is minimized.

Now referring back to FIG. 6, the dynamic display ad module receives and executes the animation sequence (i.e. 602 in FIG. 6), by reading the animation sequence and communicating with the digital flyer system to render the dynamic display ad. In this embodiment, the dynamic display ad system sends the animation sequence and not the interest areas (i.e. part of the image of the digital flyer representing the interest areas). Instead, the dynamic display ad module retrieves the interest areas from the digital flyer system and render the animation according to the animation sequence. Also, as previously discussed in the disclosure, the dynamic display ad system and the digital flyer system may be a single system or more than two systems performing the functions as described herein. The division into dynamic display ad system and digital flyer system is provided herein as illustrative purpose only.

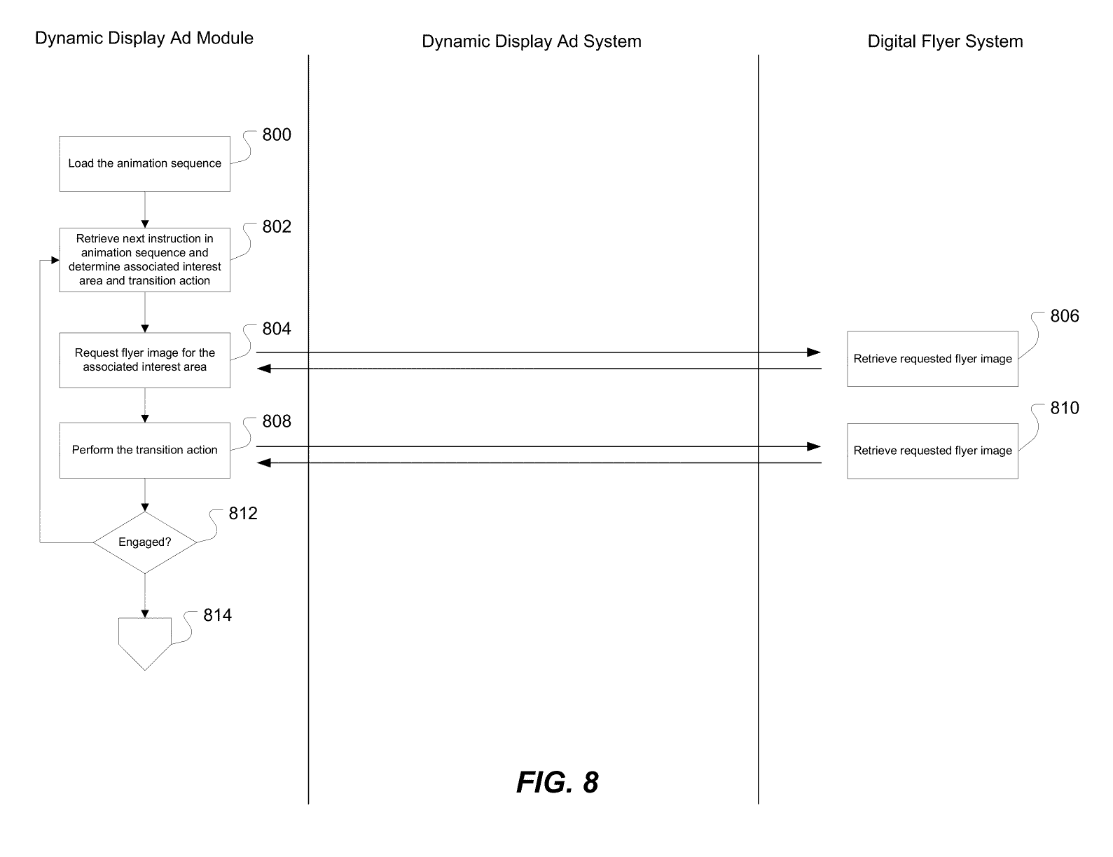

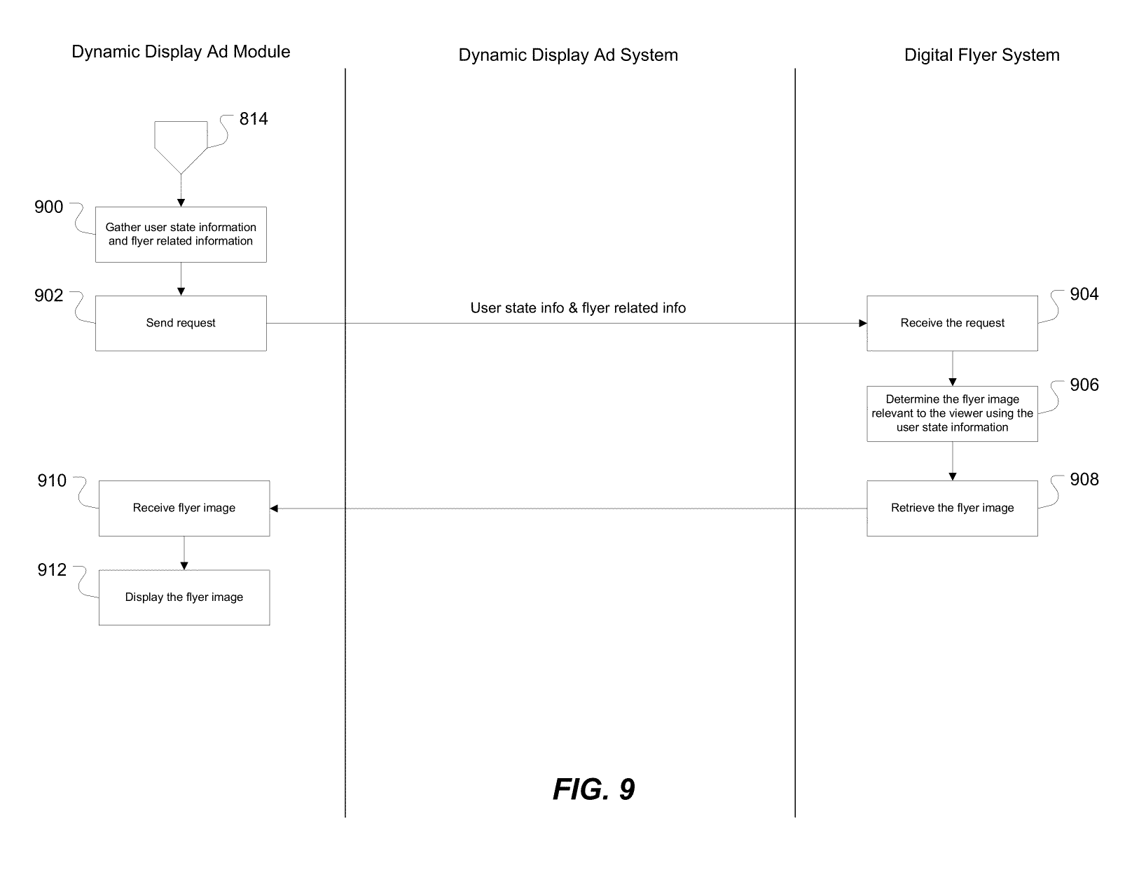

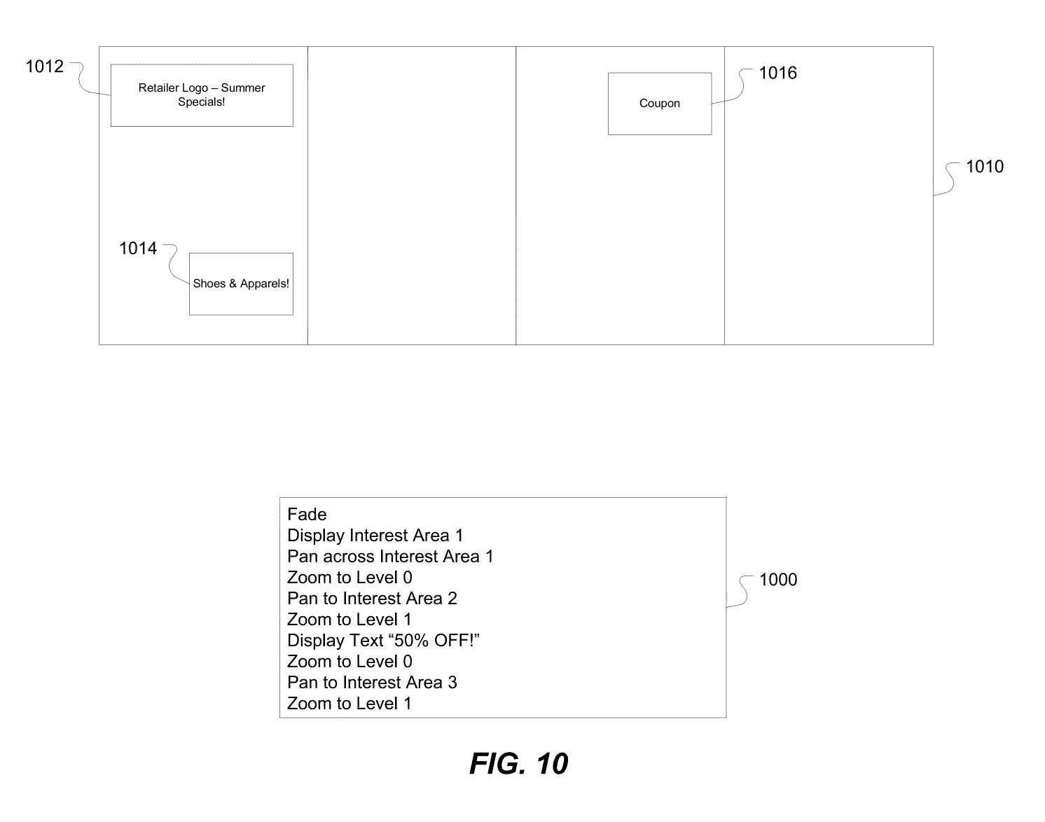

Referring to FIGS. 8 and 9, an exemplary process for executing the animation sequence using the dynamic display ad module is shown. The dynamic display ad module loads the animation sequence received from the dynamic display ad system (i.e. 800 in FIG. 8). The dynamic display ad module retrieves the next instruction in the animation sequence to determine the associated one or more interest areas and the transition action, if any, associated with the one or more interest areas (i.e. 802 in FIG. 8). For example, the transition action may be a pan, pause, zoom, fade, rotate or any combination thereof, to transition smoothly from one interest area to the next.

The dynamic display ad module sends a request to the digital flyer system for the flyer image representing the one or more interest areas (i.e. 804 in FIG. 8). This allows for efficient use of communication bandwidth to ensure that the dynamic display ads according to the present disclosure are loaded quickly. The digital flyer system receives the request and retrieves the requested flyer images, which are sent to the dynamic display ad module (i.e. 806 in FIG. 8). In one embodiment, the flyer images associated with the digital flyer are in the form of flyer tile images, such as those disclosed in the Commonly Owned patent applications—Digital Flyer System. Also, as further described in this disclosure, the next sequence in the animation sequence may be simply a transition action without an associated interest area, in which case request (i.e. 804 in FIG. 8) and retrieval (i.e. 806 in FIG. 8) are not required. An example of such a sequence is described in FIGS. 10-13. Moreover, in addition to the request for the flyer image for the current interest area, the dynamic display ad module may pre-load images in other interest areas. Since the dynamic display ad module has access to the entire animation sequence, it is able to determine the upcoming interest areas and associated transition actions. Further, the dynamic display ad module may pre-load flyer images that may be shown during the performance of the transition action.

The dynamic display ad module executes the transition action (i.e. 808 in FIG. 8), which may involve retrieving additional flyer image that may be shown during the transition action (i.e. 810 in FIG. 8). The dynamic display ad module retrieves the next instruction in the animation sequence and the process repeats until all the instructions in the animation sequence are executed. If at any time during the execution of the animation sequence, the dynamic display ad module detects an engagement (i.e. 812 in FIG. 8), the dynamic display ad module may trigger a secondary experience for the viewer (i.e. 814 in FIG. 8). An engagement may be a mouseover, dick, or any other forms of interaction that a viewer of the dynamic display ad may perform. In one embodiment, the secondary experience is an overlay of the full interactive digital flyer. The full interactive digital flyer may be implemented using an interactive digital flyer such as those disclosed in Commonly Owned patent applications—Digital Flyer System.

As shown in FIG. 9, where the dynamic display ad module triggers a secondary experience, the dynamic display ad module collects user state information and information regarding the flyer currently being shown in the dynamic display ad (i.e. 900 in FIG. 9). Examples of user state information include viewport information, position of the digital flyer or the flyer image in the dynamic display ad, browser information, device information, and other relevant user state information to seamlessly transition the viewer from the dynamic display ad to the secondary experience. The collected information is then sent to the digital flyer system and received by the digital flyer system (i.e. 902 and 904 in FIG. 9). With the received request, the digital flyer system determines the flyer image relevant to the viewer using the user state information (i.e. 906 in FIG. 9). For example, if the digital flyer system implements flyer image tiles such as those disclosed in Commonly Owned patent applications—Digital Flyer System, the digital flyer system retrieves the flyer image tiles visible in the viewport of the viewer and sends the retrieved flyer image tiles to the dynamic display ad module. In one embodiment, the digital flyer system may retrieve one or more flyer images visible in the viewport. In another embodiment, the digital flyer system may retrieve additional images (i.e. pre-load) likely to be retrieved by the viewer but not yet displayable in the viewport of the communication device. The digital flyer system may incorporate the pre-loading techniques described in the Commonly Owned patent applications—Digital Flyer System and/or in the Common Owned patent application—Pre-Loading. The digital flyer system retrieves the determined flyer image and sends the retrieved flyer images to the dynamic display ad module (i.e. 908 in FIG. 9). The dynamic display ad module receives the retrieved flyer image and displays the flyer image in the secondary experience (i.e. 910 and 912 in FIG. 9).

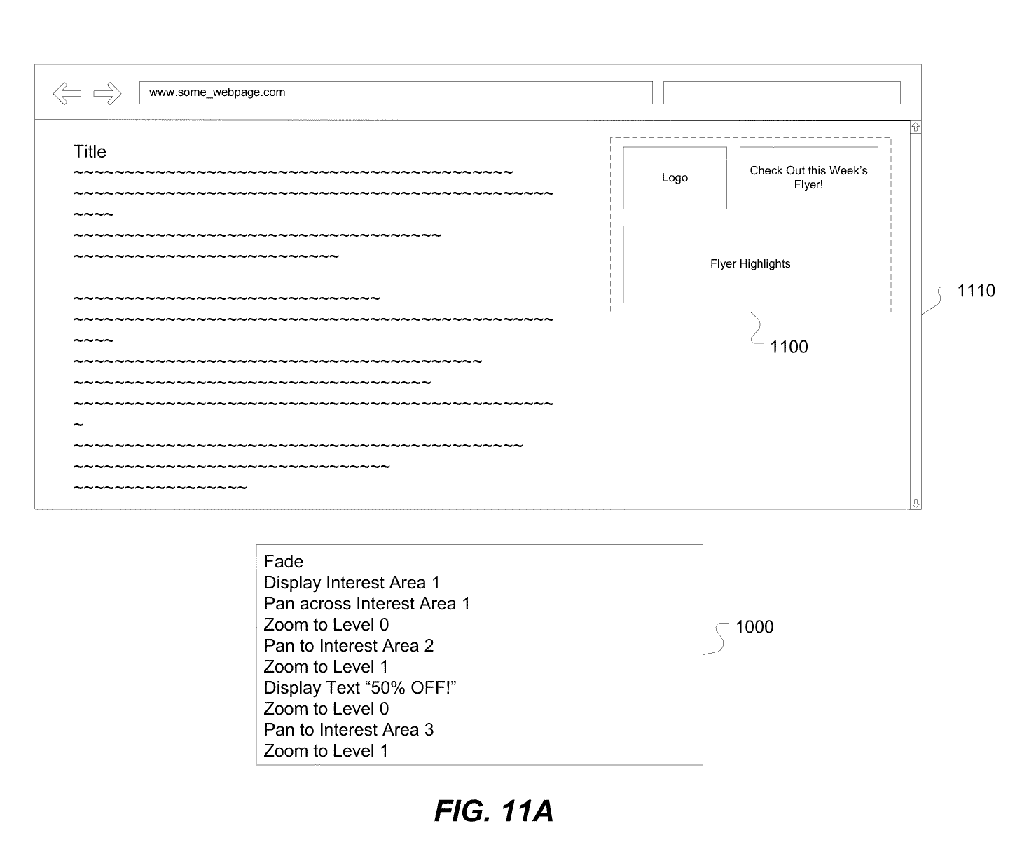

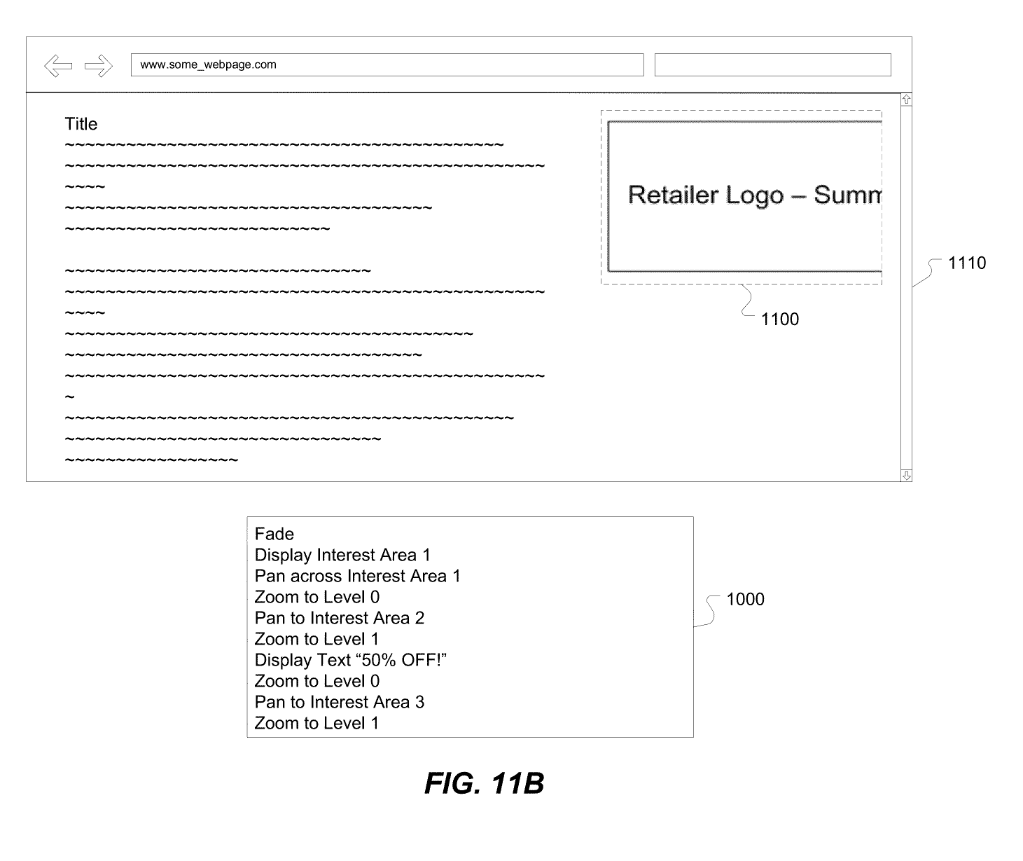

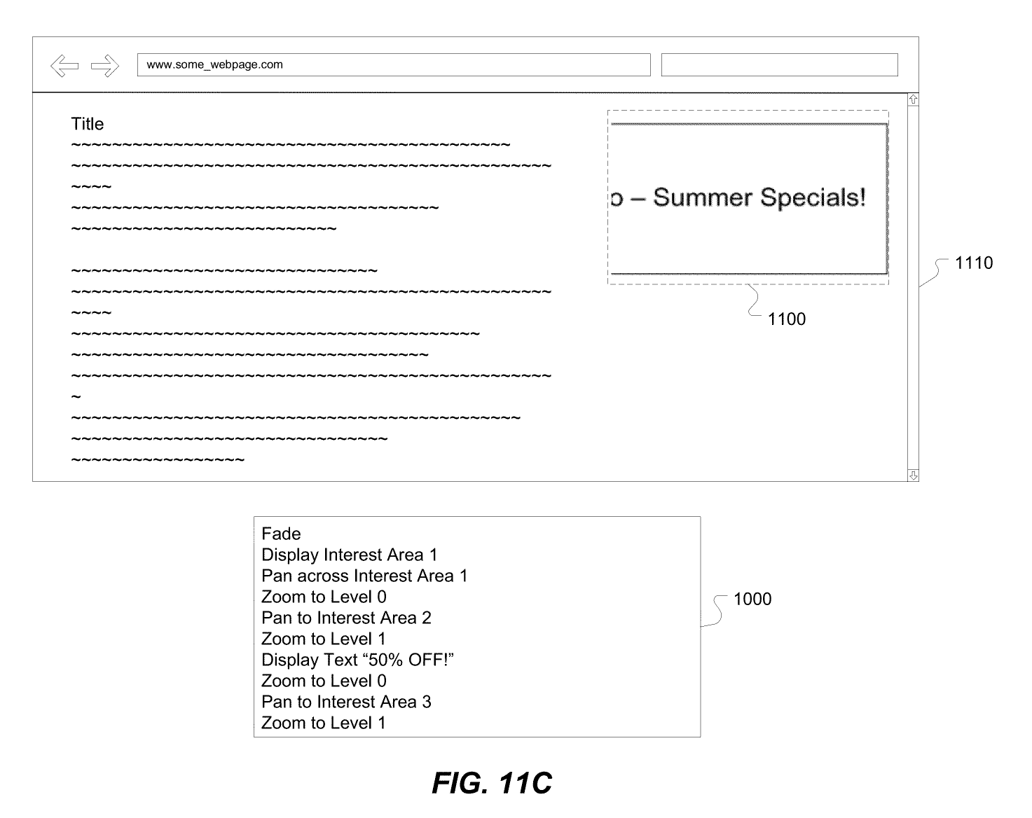

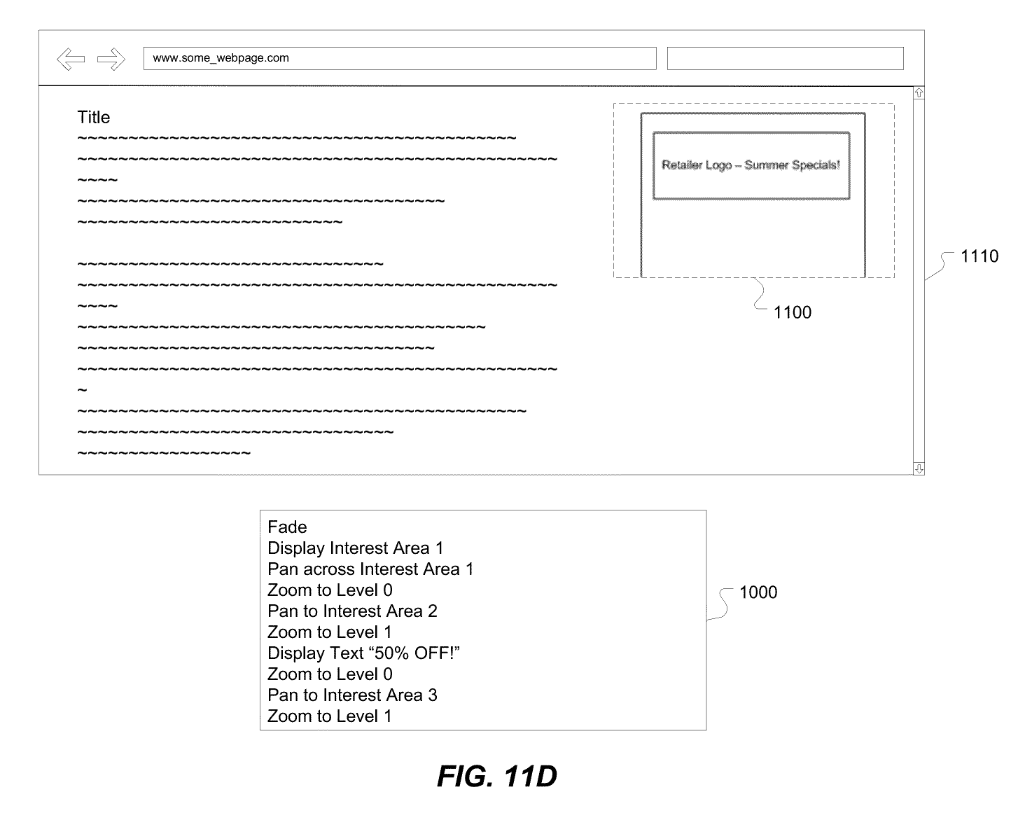

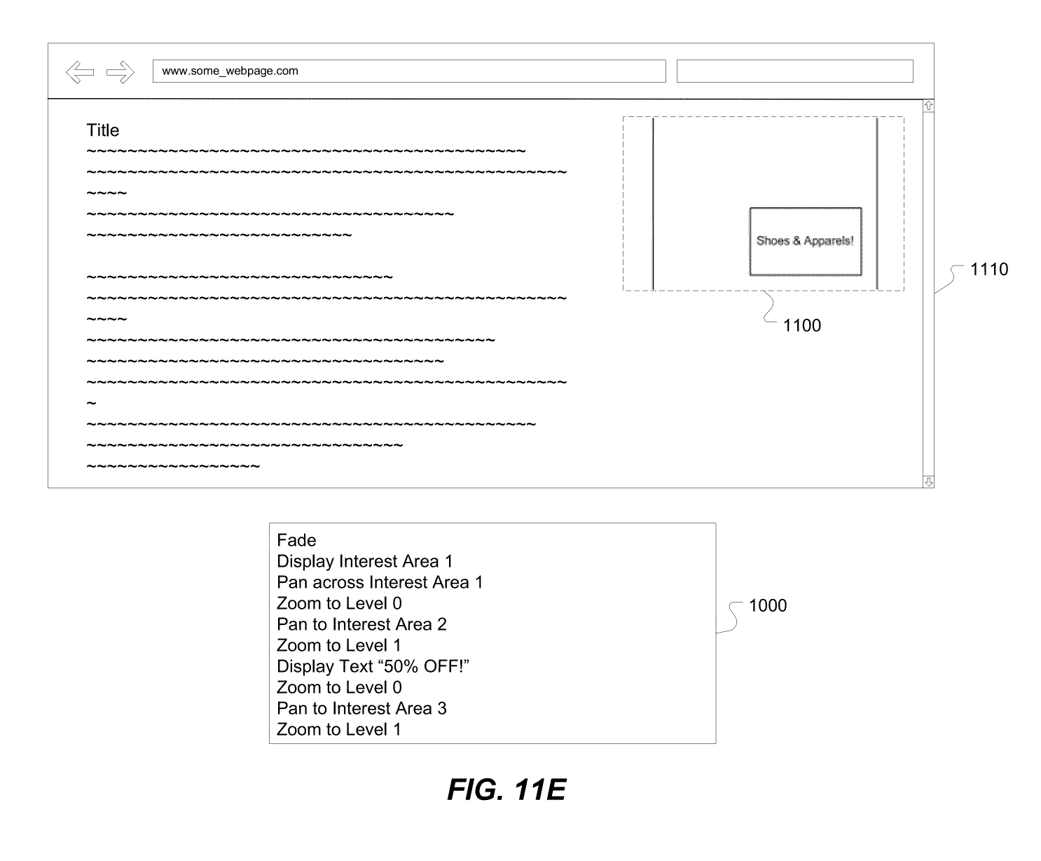

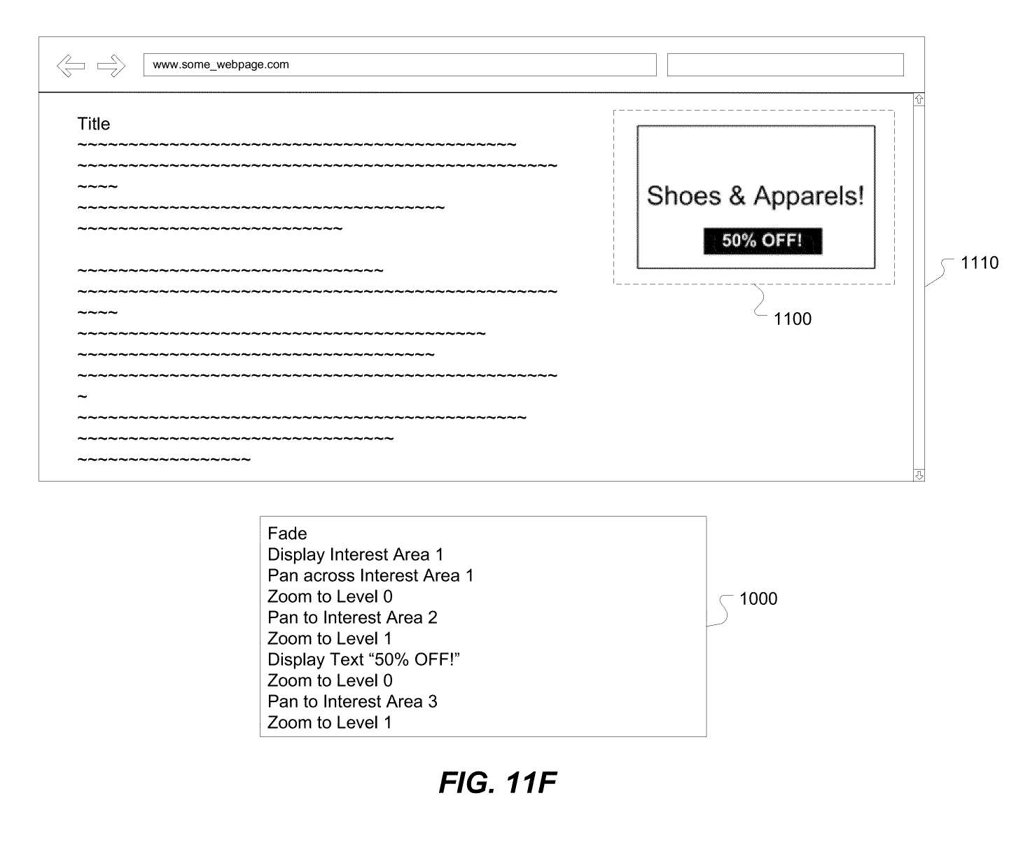

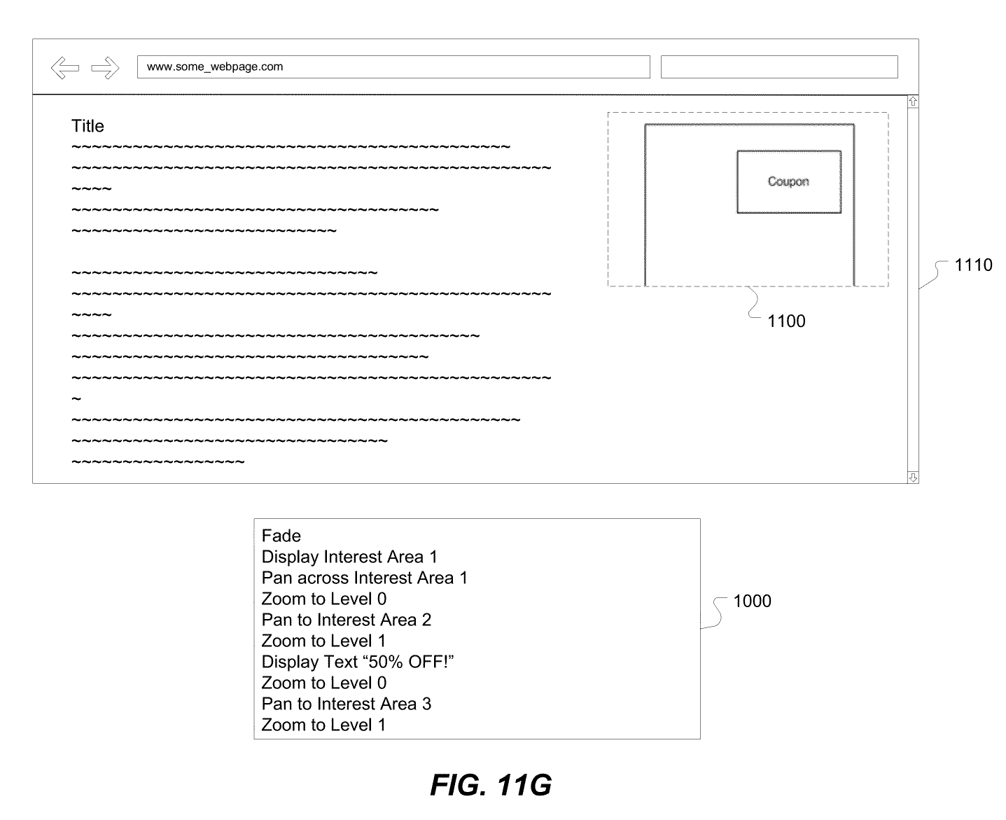

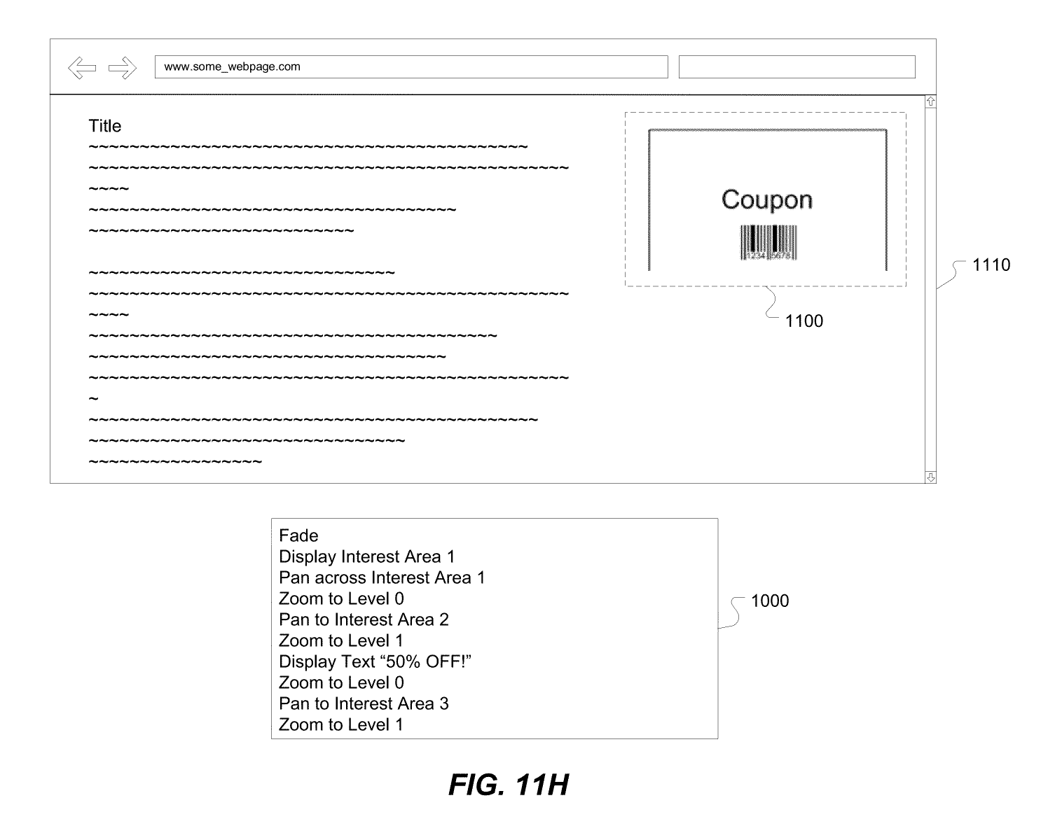

Now referring to FIGS. 10 and 11A-11I, an exemplary execution of an animation sequence 1000 is shown. The animation sequence 1000 and figures shown have been intentionally simplified for illustration purposes. In FIG. 10, an animation sequence 1000 and the selected digital flyer 1010 are shown. The selected digital flyer 1010 has three interest areas 1012, 1014 and 1016, which have been determined by the dynamic display ad system and an accompanying animation sequence 1000 has been generated and sent to the dynamic display ad module.

In FIG. 11A, a dynamic display ad 1100 is shown embedded into webpage 1110. As shown in FIG. 11A, the dynamic display ad 1100 is displaying the initial image, organized using a template. It will be understood that different templates may be available for the initial image and the initial image may be manually created without using a template. As shown in animation sequence 1000, the first action to be executed by the dynamic display ad module is a “fade” action, which may be executed using any number of known methods to the person skilled in the art. This allows the dynamic display ad 1100 to transition to the Interest Area 1, which is displayed in FIG. 11B. Since configuration information regarding the dynamic display ad was conveyed to the dynamic display ad system, the dynamic display ad system is aware that an action to “pan across Interest Area 1” is required since the entire Interest Area 1 cannot be visible within the dynamic display ad 1100. As shown in FIG. 11C, the dynamic display ad pans across the Interest Area 1 showing the viewer the entire Interest Area 1. Thereafter, the dynamic display ad zooms to “Level 0” as shown in FIG. 11D followed by a “pan to Interest Area 2” as shown in FIG. 11E. When the dynamic display ad 1100 reaches the Interest Area 2, a zoom to “Level 1” is executed by the dynamic display ad module to showcase the interest area (i.e. FIG. 11F). In addition, in this animation sequence, a display text is added to further add emphasis to the Interest Area 2. Finally, the dynamic display ad zooms to “Level 0” (similarly as shown in FIG. 11E) and executed a “pan to Interest Area 3” action, which is shown in FIG. 11G. The showcase of the selected digital flyer is finished by zooming to “Level 1” to show the coupon as shown in FIG. 11H. Thus, as shown in FIG. 11I, the flyer content shown in the dynamic display ad 1100 is the flyer content in the path 1120, thereby showcasing the interest areas, derived from live flyer content, on the digital flyer

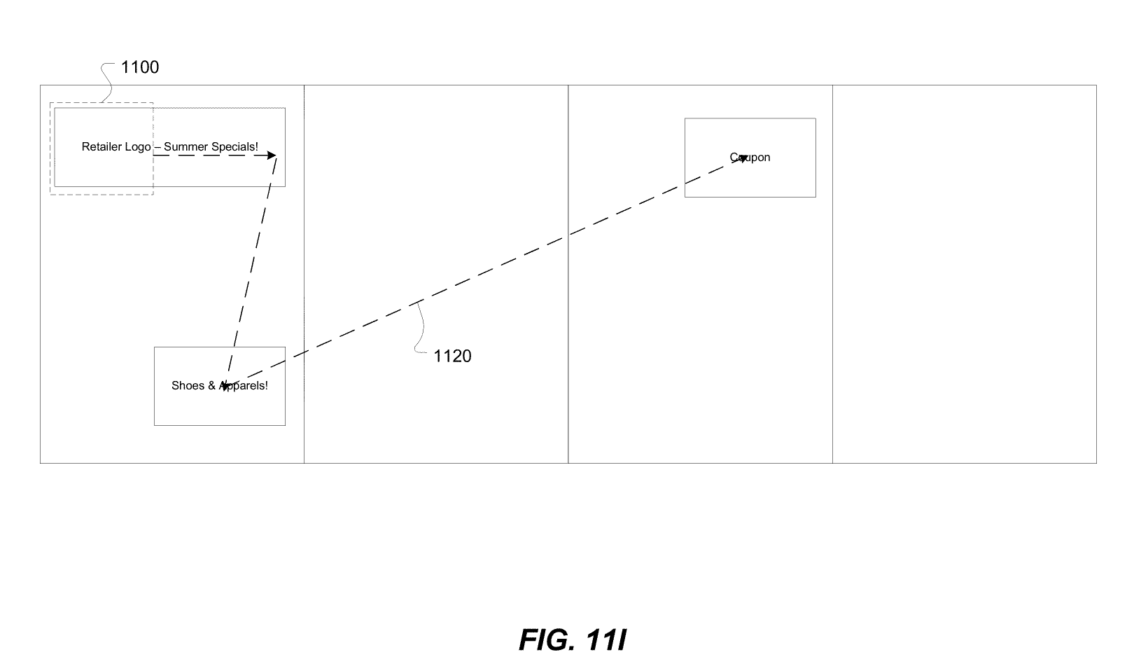

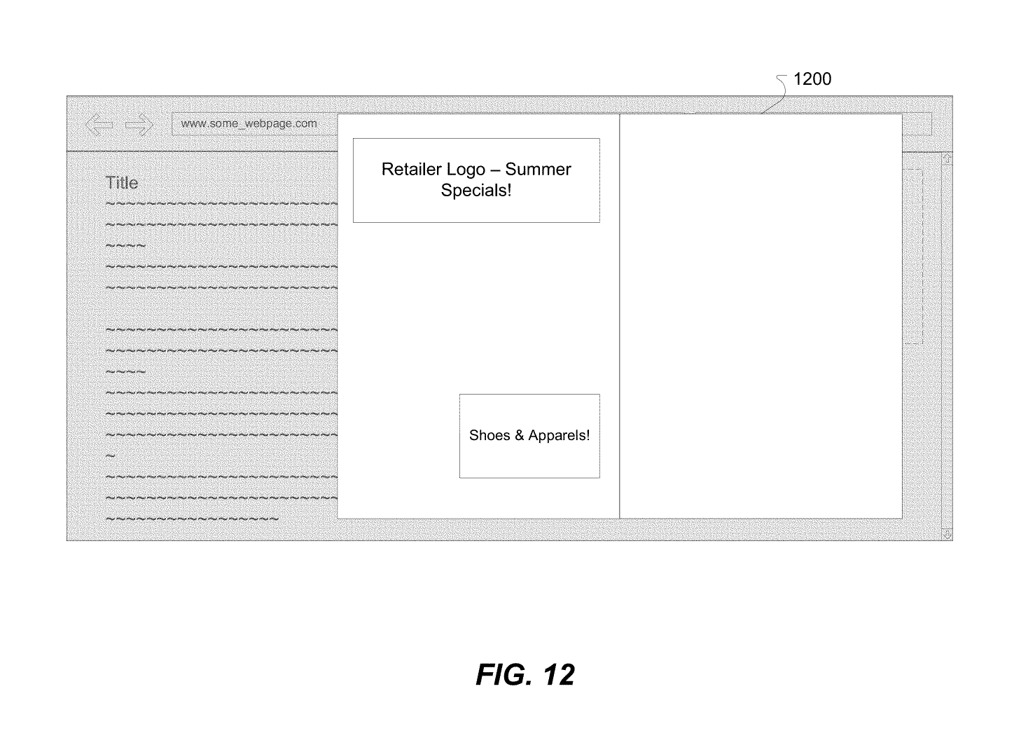

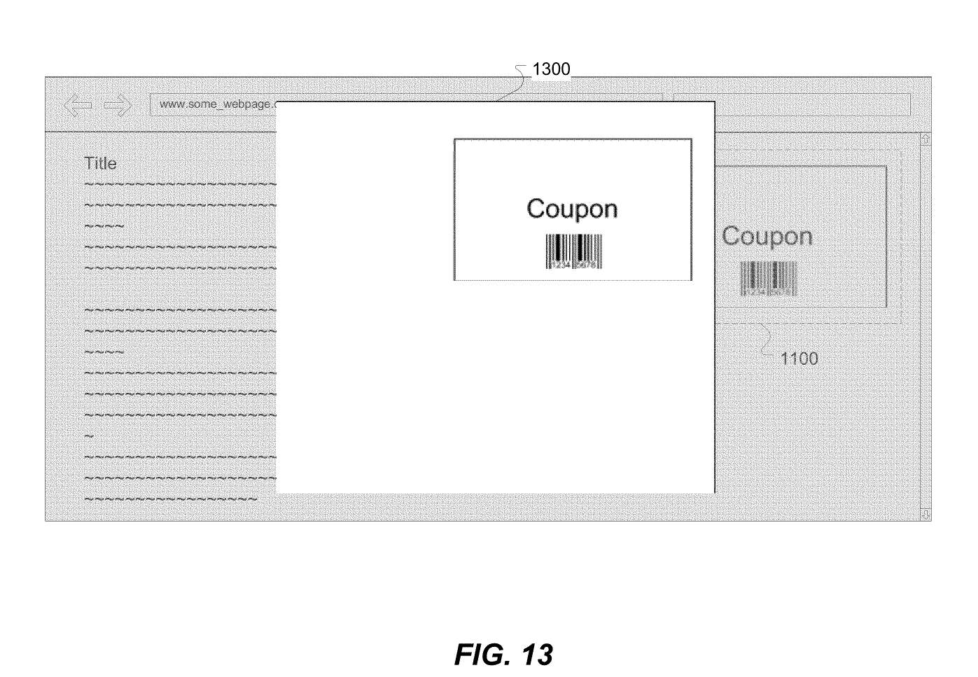

In a further embodiment, when the viewer interacts with the dynamic display ad (e.g. dynamic display ad 1100), a secondary experience may be triggered. In one embodiment, the webpage containing the dynamic display ad may be unfocused as shown in FIG. 12. When the dynamic display ad detects an engagement or otherwise an interaction with the dynamic display ad, user state information and flyer related information are gathered and sent to the digital flyer system. The digital flyer system retrieves the relevant flyer images so that the full digital flyer may be displayed to the viewer at the relevant location on the digital flyer. For example, referring to FIG. 11E, if the viewer engages the dynamic display ad 1100 as shown, the dynamic display ad module gathers user state information and flyer-related information. The user state information may include such information as the relative position of the digital flyer shown in the dynamic display ad 1100 and size and resolution of the viewport. Flyer-related information may include information regarding the digital flyer shown in the dynamic display ad 1100 and the animation sequence being executed immediately prior to the engagement. This information is used to retrieve the digital flyer and create the secondary experience, such as the secondary experience shown in FIG. 12. In a further example, referring to FIG. 11H, if the viewer engages the dynamic display ad 1100 as shown, the secondary experience 1300 is shown in FIG. 13. As shown, the secondary experience reflects the animation sequence being executed in the dynamic display ad 1100 prior to the engagement. The secondary experience 1300 in FIG. 13 shows a zoomed-in portion of the digital flyer containing the coupon, with which the viewer engaged prior to the trigger of the secondary experience.

### Server Side Dynamic Display Ad Creation

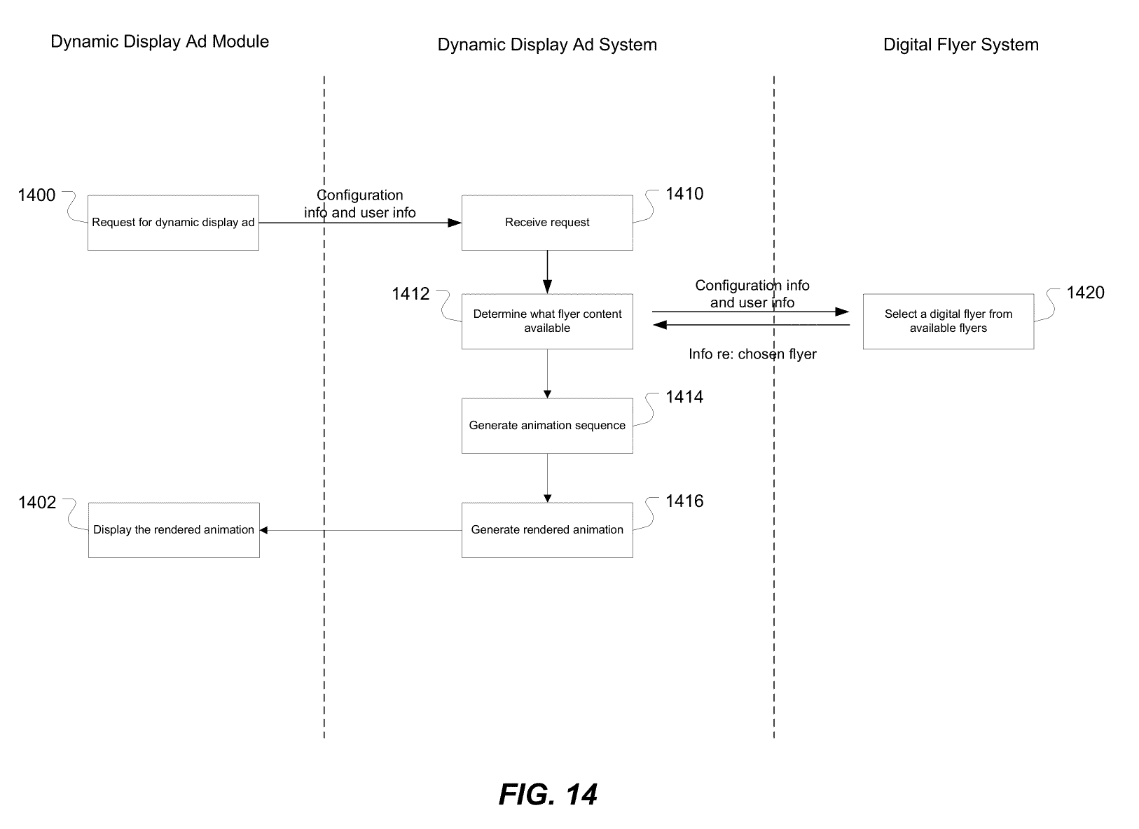

While the embodiments described above discuss the dynamic display ad module receiving the animation sequence and communicating with the dynamic display ad system or the digital flyer system to render the dynamic display ad using flyer content of the selected digital flyer, it will be understood that the rendering of the animation sequence may be performed by the dynamic display ad system. Also, as previously discussed, the dynamic display ad system and the digital flyer system may be a single system and thus, the embodiments described in FIGS. 14-16 equally apply to an embodiment of the present disclosure wherein the dynamic display ad system is co-located or is the same system as the digital flyer system. Such embodiments will now be described using FIGS. 14-16.

Referring to FIGS. 2 and 5, the content retrieved from publisher content server 222 may contain an ad placeholder 504 as shown in FIG. 5, which may be in the form of an ad tag as described herein. The ad tag may direct the web page 500 to the publisher ad server 224 or dynamic display ad system 226 depending on how the advertiser (or the service provider of the advertiser) chooses to implement the dynamic display ad according to the embodiments described in the present disclosure. The ad tag also retrieves a dynamic display ad module configured to communicate with the dynamic display ad system. However, in this embodiment, the dynamic display ad module may be “lighter” than the dynamic display ad module previously discussed. This module does not render the flyer content using the animation sequence; rather, it receives the animation that was rendered by the dynamic display ad system using the animation sequence. This animation will be herein referred to as “rendered animation”.

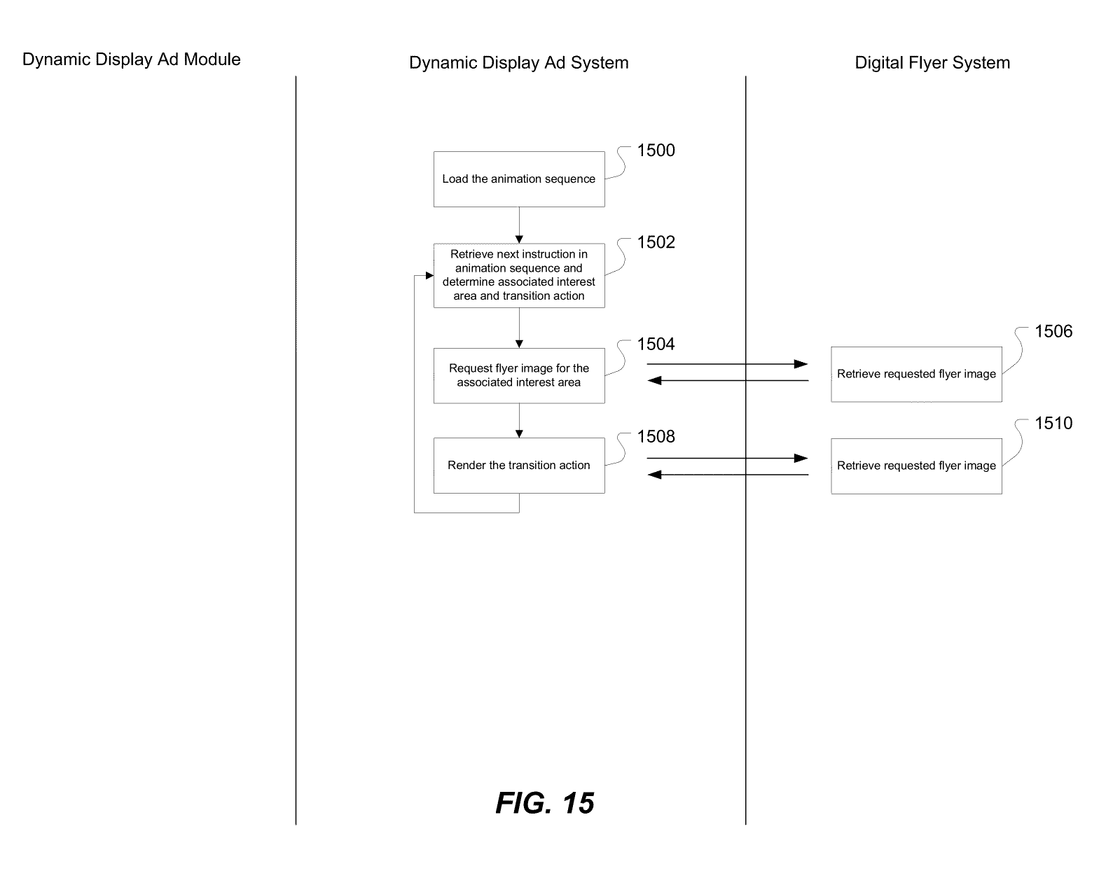

Referring to FIG. 14, the dynamic display ad module requests for a dynamic display ad (i.e. 1400 in FIG. 14). In one embodiment, the dynamic display ad module may gather configuration information and user related information and incorporate such information to the request. This request is received by the dynamic display ad system (i.e. 1410 in FIG. 14) and the dynamic display system selects the digital flyer from which to generate the animation sequence. In one embodiment, this involves sending a request to the digital flyer system to determine what digital flyer(s) are available (i.e. 1412 and 1420 in FIG. 14). The digital flyer system determines the available digital flyer(s) and selects one of the available digital flyer(s). In one embodiment, a random digital flyer may be selected. In another embodiment, a digital flyer may be selected using one or more criteria, including configuration information, user related information, or flyer-related information, or a combination thereof. The chosen digital flyer is communicated to the dynamic display ad system, from which the animation sequence is generated (i.e. 1414 in FIG. 14) using any of the embodiments discussed herein. With the animation sequence generated, instead of sending the animation sequence to the dynamic display ad module to be rendered, the dynamic display ad system generates a rendered animation using the generated animation sequence (i.e. 1416 in FIG. 14). In one embodiment, generating the rendered animation involves retrieving a previously generated rendered animation from memory. In another embodiment, generating the rendered animation involves rendering the animation sequence in real-time, an embodiment which is shown in FIG. 15. In other words, the flyer content for display in the dynamic display ad is rendered by the dynamic display ad system rather than the dynamic display ad module. The rendered animation is sent to the dynamic display ad module to be displayed in the dynamic display ad (i.e. 1402 in FIG. 14). Additionally, the dynamic display ad system may pre-render one or more of the animation sequences depending on one or more criteria. The criteria for pre-rendering may be based on one or more intrinsic factors, one or more extrinsic factors, one or more feedback information or a combination thereof. The pre-rendered animation sequences may be stored in memory for later retrieval. In a further embodiment, dynamic display ad system may send an initial image of the selected digital flyer to the dynamic display ad module while the animation sequence is generated and executed. The initial image of the selected digital flyer may be generated as discussed herein.

Now referring to FIG. 15, an embodiment for rendering the animation sequence is shown. In this embodiment, the dynamic display ad system loads the animation sequence (i.e. 1500 in FIG. 15). The animation sequence may have been previously generated as discussed in this disclosure. For example, the dynamic display ad system may have previously created the animation sequence using the process as described in FIG. 7 and stored in memory. In another example, the dynamic display ad system may create the animation sequence in real-time and load the created animation sequence. In a further example, the dynamic display ad system may have pre-generated one or more animation sequence depending on one or more criteria and retrieved from memory for use.

With the animation sequence loaded, the dynamic display ad system retrieves a next instruction in the animation sequence and determines the associated one or more interest areas and the transition action, if any, associated with the one or more interest areas (i.e. 1502 in FIG. 15). The dynamic display ad system retrieves the flyer image representing the interest area from the digital flyer system (i.e. 1504 and 1506 in FIG. 15). In addition to the flyer image representing the interest area, the dynamic display ad system may also retrieve flyer image displayable in the dynamic display ad during the execution of the one or more transition actions (i.e. 1508 and 1510 in FIG. 15). In one embodiment, the flyer images associated with the digital flyer are in the form of flyer tile images, such as those disclosed in the Commonly Owned patent applications—Digital Flyer System. The dynamic display ad system repeats the retrieval of the next instruction, and flyer image(s) associated with the interest area and the transition action until all of the instructions in the animation sequence are complete (i.e. 1502-1510 in FIG. 15). The rendered animation is then sent to the dynamic display ad module to be displayed as a dynamic display ad. Alternatively, the rendered animation may be stored in memory for later retrieval.

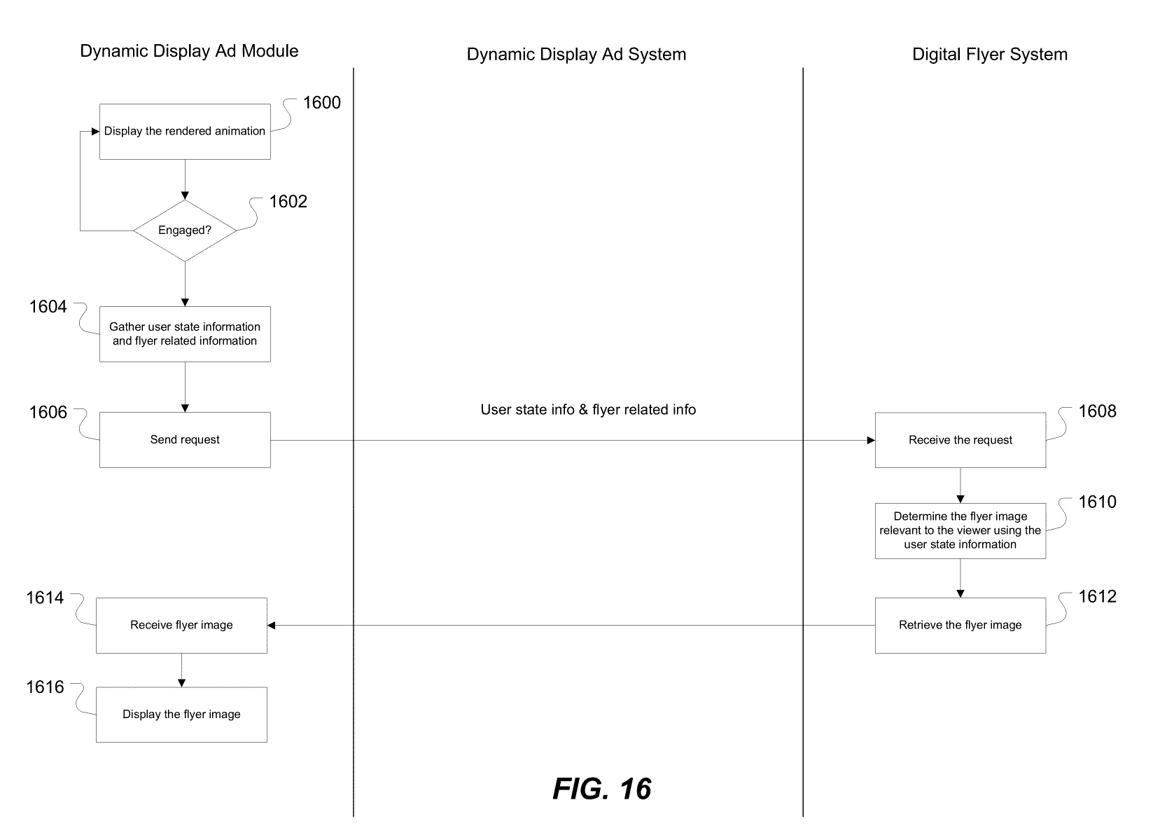

Now referring to FIG. 16, an embodiment for triggering a secondary experience is disclosed. The dynamic display ad module displays the rendered animation received from the dynamic display ad system (i.e. 1600 in FIG. 16). In one embodiment, the dynamic display ad module downloads the full rendered animation prior to displaying the rendered animation. In another embodiment, the dynamic display ad module may display the rendered animation as it is received from the dynamic display ad system (i.e. stream the rendered animation). The displaying of the rendered animation continues until an engagement or interaction is detected (i.e. 1602 in FIG. 16). In the event that an engagement or interaction is detected, a secondary experience is triggered. In one embodiment, the dynamic display ad module may collect user state information and flyer related information (i.e. 1604 in FIG. 16), which may be conveyed to the digital flyer system with the request for the digital flyer displayed in the dynamic display ad (i.e. 1606 in FIG. 16). By incorporating the collected information with the request, a more seamless transition may be made possible. For example, if the viewer of the dynamic display ad was hovering over interest area 1, by collecting state information, the secondary experience may be triggered such that the full digital flyer may be shown at the interest area 1. In another example, the dynamic display ad module may simply display the digital flyer at a predetermined location without considering user state information.

The digital flyer system receives the request (i.e. 1608 in FIG. 16) and determines the flyer image relevant to viewer (i.e. 1610 in FIG. 16). In one embodiment, relevance refers to flyer images that are displayable in the viewport of the communication device on which the viewer views the dynamic display ad. In another embodiment, relevance refers to flyer images that are not yet displayable in the viewport but likely to be displayable (i.e. pre-load). The digital flyer system may incorporate the pre-loading techniques described in the Commonly Owned patent applications—Digital Flyer System and/or in the Common Owned patent application—Pre-Loading. The relevant flyer images are retrieved and sent to the dynamic display ad module to be displayed (i.e. 1612-16 in FIG. 16). The examples discussed in FIGS. 10 and 11A-11I similarly applies to the embodiments discussed in FIGS. 14-16.

Thus, as discussed in this disclosure, retailers may have many different versions of the digital flyer depending on the applicable parameters. For example, viewers in New York, N.Y. may be presented with a different digital flyer from viewers in New Jersey, New York. This may be as simple as different pricing zones for different geographic regions or in other cases, the digital flyer may contain different items that may interest the residents of different geographic regions. For example, in the winter months, viewers in Miami, Fla. may be presented with sunglasses and t-shirts while viewers in Buffalo, N.Y. may be presented with shovels and winter gloves. Because of the weekly or “fresh” nature of the content embodied in a flyer, and the potential varying content within such flyer, generating display ads using the actual content of the digital flyer has been very time consuming and often impractical. However, using the dynamic display ads disclosed herein, the dynamic display ad system is able to create targeted content in the dynamic display ad depending on the user information conveyed by the dynamic display ad. In one embodiment, this is achieved by determining the interest areas on the selected digital flyer. Since the digital flyer is selected by the digital flyer system using user information, the interest areas determined by the dynamic display ad system are targeted to the viewer of the dynamic display ad. Even if the retailer associated with the selected digital flyer only has a single version, the dynamic display ad system may use the user information to generated multiple variants of the interest areas. For example, viewers using the latest internet browser may be presented with deals relating to high tech deals while viewers using older internet browser typically found in an office environment, may be presented with other deals relevant to such user. In a further embodiment, the determined interest areas may vary depending on the time during which the viewer may be presented with the dynamic display ad. Depending on the time of the day, the determined interest areas may be altered. In an even further embodiment, user information may be used to retrieve related information such as weather information to help determine the interest areas on the digital flyer. While the foregoing has been described such that the dynamic display ad system determines the interest areas on the digital flyer, it will be understood that the digital flyer system may use the relayed user information and configuration information to determine the interest areas on the digital flyer.

While the patent disclosure is described in conjunction with the specific embodiments, it will be understood that it is not intended to limit the patent disclosure to the described embodiments. On the contrary, it is intended to cover alternatives, combinations, modifications, and equivalents as may be included within the scope of the patent disclosure as defined by the appended claims. In the description below, numerous specific details are set forth in order to provide a thorough understanding of the present patent disclosure. The present patent disclosure may be practiced without some or all of these specific details. In other instances, well-known process operations have not been described in detail in order not to unnecessarily obscure the present patent disclosure.

It is further understood that the use of relational terms such as first and second, and the like, if any, are used solely to distinguish one from another entity, item, or action without necessarily requiring or implying any actual such relationship or order between such entities, items or actions.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Some portions of the detailed description in the above are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the above discussions, it is appreciated that throughout the specification discussions utilizing terms such as “processing,” “computing,” “calculating,” “determining,” or the like, refer to the action and/or processes of a computer or computing system, or similar electronic computing media player device, that manipulate and/or transform data represented as physical, such as electronic, quantities within the computing system's registers and/or memories into other data similarly represented as physical quantities within the computing system's memories, registers or other such information storage, transmit session or display devices.

Embodiments within the scope of the present disclosure can be implemented in digital electronic circuitry, or in computer hardware, firmware, software, or in combinations thereof. Apparatus within the scope of the present disclosure can be implemented in a computer program product tangibly embodied in a machine-readable storage medium for execution by a programmable processor; and method actions within the scope of the present disclosure can be performed by a programmable processor executing a program of instructions to perform functions of the present disclosure by operating on input data and generating output. Embodiments within the scope of the present disclosure may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files. Embodiments within the scope of the present disclosure include computer-readable media for carrying or having computer-executable instructions, computer-readable instructions, or data structures stored thereon. Such computer-readable media may be any available media, which is accessible by a general-purpose or special-purpose computer system. Examples of computer-readable media may include physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system. Any of the foregoing can be supplemented by, or incorporated in, ASICs (application-specific integrated circuits). It should be understood that embodiments of the present disclosure may be used in a variety of applications. Although the present disclosure is not limited in this respect, the methods disclosed herein may be used in many apparatuses such as in the transmitters, receivers and transceivers of a radio system. Radio systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDA's), notebook computers in wireless local area networks (WLAN), wireless metropolitan area networks (WMAN), wireless wide area networks (WWAN), or wireless personal area networks (WPAN, and the like).

What is claimed is:

1. A method executed on a communication device, the method comprising:
requesting for a dynamic display ad from a dynamic display ad system;
receiving an animation sequence from the dynamic display ad system, the animation sequence comprising one or more instructions to show one or more interest areas on a selected digital flyer; and
displaying the dynamic display ad using the animation sequence, wherein the animation sequence is used to render the dynamic display ad using flyer content of the selected digital flyer.

2. The method according to claim 1, further comprising:
displaying an initial image of the selected digital flyer received from the dynamic display ad system.

3. The method according to claim 1, wherein the one or more interest areas of the selected digital flyer are determined using one or more intrinsic factors, one or more extrinsic factors, one or more feedback information, or a combination thereof.

4. The method according to claim 1, wherein the animation sequence further comprises one or more transition actions.

5. The method according to claim 1, wherein displaying the dynamic display ad using the animation sequence comprises:
retrieving a next instruction of the animation sequence;
requesting, to the dynamic display ad system, for a flyer image representing the interest area in the next instruction;
displaying the flyer image received from the dynamic display ad system; and
repeating the retrieval of a next instruction, request for a flyer image and display of the flyer image for all instructions in the animation sequence.

6. The method according to claim 5, wherein the animation sequence comprises one or more transition actions and the method further comprising:
requesting, to the dynamic display ad system, for a flyer image displayable in the dynamic display ad during execution of one of the one or more transition actions; and
displaying the flyer image received from the dynamic display ad system.

7. The method according to claim 5, further comprising:
requesting, to the dynamic display ad system, for a flyer image representing the interest area not yet displayable in the dynamic display ad.

8. The method according to claim 1, further comprising:
detecting an interaction with the dynamic display ad; and
triggering a secondary experience.

9. The method according to claim 8, wherein triggering a secondary experience comprises:
requesting, to the dynamic display ad system, for the flyer image of the selected digital flyer displayable in a viewport of the communication device; and
displaying the flyer image received from the dynamic display ad system.

10. The method according to claim 9, wherein displaying the flyer image received from the dynamic display ad system comprises overlaying the received flyer image over the dynamic display ad.

11. The method according to claim 1, further comprising:
collecting user state information of the user viewing the dynamic display ad on the communication device; and
incorporating the collected user state information with the request for the dynamic display ad.

12. The method according to claim 1, further comprising:
collecting configuration information of the dynamic display ad; and
incorporating the collected configuration information with the request for the dynamic display ad.

13. A system for displaying dynamic display ad on a communication device, the system comprising a dynamic display ad module configured to:
request for a dynamic display ad from a dynamic display ad system;
receive an animation sequence from the dynamic display ad system, the animation sequence comprising instructions to show one or more interest areas on the selected digital flyer; and
display the dynamic display ad using the animation sequence, wherein the animation sequence is used to render the dynamic display ad using flyer content of the selected digital flyer.

14. The system according to claim 13, where the dynamic display ad module is further configured to:
display an initial image of the selected digital flyer received from the dynamic display ad system.

15. The system according to claim 13, wherein to display the dynamic display ad using the animation sequence, the dynamic display ad module is configured to:
retrieve a next instruction of the animation sequence;
retrieve, to the dynamic display ad system, for a flyer image representing the interest area in the next instruction;
retrieve the flyer image received from the dynamic display ad system and
repeat the retrieval of a next instruction, request for a flyer image and display of the flyer image for all instructions in the animation sequence.

16. The system according to claim 15, wherein the animation sequence comprises one or more transition actions and the dynamic display ad module is further configured to:
request, to the dynamic display ad system, for a flyer image displayable in the dynamic display ad during execution of one of the one or more transition actions; and
display the flyer image received from the dynamic display ad system.

17. The system according to claim 15, wherein the dynamic display ad module is further configured to:
request, to the dynamic display ad system, for a flyer image representing the interest area not yet displayable in the dynamic display ad.

18. The system according to claim 13, wherein the dynamic display ad module is further configured to:
detect an interaction with the dynamic display ad; and
trigger a secondary experience.

19. The system according to claim 18, wherein to trigger a secondary experience, the dynamic display ad module is configured to:
request, to the dynamic display ad system, for the flyer image of the selected digital flyer displayable in a viewport of the communication device; and
display the flyer image received from the dynamic display ad system.

20. The system according to claim 19, wherein the dynamic display ad module is further configured to:
request, to the dynamic display ad system, for the flyer image of the selected digital flyer not yet displayable in a viewport of the communication device.

21. The system according to claim 18, wherein the dynamic display ad module is further configured to:
collect user state information of the user viewing the dynamic display ad on the communication device and
incorporate the collected user state information with the request for the flyer image.

22. The system according to claim 21, wherein the user state information comprises viewport information, position of the flyer image, browser information, device information or a combination thereof.

23. The system according to claim 18, wherein the dynamic display ad module is further configured to:
collect flyer-related information of the digital flyer being displayed in the dynamic display ad; and
incorporate the collected flyer-related information with the request for the flyer image.

24. A method executed on a computer system, the method comprising:
selecting a digital flyer from available digital flyer in response to a request for a dynamic display ad received from a dynamic display ad module;
generating an animation sequence based on the selected digital flyer, the animation sequence comprising one or more instructions to show one or more interest areas on the selected digital flyer; and
sending the animation sequence to the dynamic display ad module.

25. The method according to claim 24, further comprising:
generating an initial image of the selected digital flyer; and
sending the initial image to be displayed by the dynamic display ad module.

26. The method according to claim 25, wherein generating an initial image of the selected digital flyer comprises retrieving a pre-generated initial image for the selected digital flyer from memory.

27. The method according to claim 25, wherein generating an initial image of the selected digital flyer comprises creating the initial image using flyer content of the selected digital flyer.

28. The method according to claim 27, wherein creating the initial image using flyer content of the selected digital flyer comprises:
selecting a template from one or more available templates; and
creating the initial image based on the selected template.

29. The method according to claim 24, wherein generating an animation sequence based on the selected digital flyer comprises retrieving a pre-generated animation sequence for the selected digital flyer from memory.

30. The method according to claim 24, wherein generating an animation sequence based on the selected digital flyer comprises creating the animation sequence based on one or more interest areas on the selected digital flyer.

31. The method according to claim 30, wherein creating the animation sequence based on one or more interest areas on the selected digital flyer comprises:
selecting a template from one or more available templates; and
creating the animation sequence based on the selected template.

32. The method according to claim 30, wherein the one or more interest areas on the selected digital flyer are determined based on one or more intrinsic factors, one or more extrinsic factors, one or more feedback information, or a combination thereof.

33. The method according to claim 24, further comprising:
pre-generating one or more animation sequences based on one or more criteria.

34. The method according to claim 33, wherein the one or more criteria for pre-generation of the one or more animation sequences comprises one or more intrinsic factors, one or more extrinsic factors, one or more feedback information, or a combination thereof.

35. The method according to claim 24, wherein the animation sequence further comprises one or more transition actions.

36. The method according to claim 35, wherein the one or more transition actions comprises a pan, pause, zoom, rotate, fade or a combination thereof.

37. The method according to claim 24, wherein the animation sequence further comprises a text, pictorial or audio-visual information.

38. The method according to claim 24, wherein the digital flyer is selected from the available digital flyer based on relevance, wherein the relevance is based on targeting information.

39. The method according to claim 38, wherein the targeting information comprises user-related information received from the dynamic display ad module.

40. The method according to claim 38, wherein the targeting information comprises flyer-related information.

41. A computer system comprising:
an animation sequence generator configured to generate an animation sequence based on a digital flyer selected from available digital flyer, the animation sequence comprising one or more instructions to show one or more interest areas on the selected digital flyer; and
a communication module configured to communicate with a dynamic display ad module to display a dynamic display ad showing the flyer content of the selected digital flyer using the generated animation sequence.

42. The system according to claim 41, further comprising:
a cover shot generator configured to generate an initial image of the selected digital flyer.

43. The system according to claim 42, wherein the cover shot generator generates the initial image by retrieving a pre-generated initial image for the selected digital flyer from memory.

44. The system according to claim 42, wherein the cover shot generator generates the initial image by creating the initial image using flyer content of the selected digital flyer.

45. The system according to claim 41, wherein the animation sequence generator retrieves a pre-generated animation sequence for the selected digital flyer from memory.

46. The system according to claim 41, wherein the animation sequence generator creates the animation sequence based on one or more interest areas on the selected digital flyer.
